(19) United States
(12) Patent Application Publication
(10) Pub. No.: US 2011/0170795 A1
(43) Pub. Date: Jul. 14, 2011

(54) FILTER DEVICE AND FILTER METHOD

(75) Inventor: Akihiko HIGUCHI, Kyoto (JP)

(73) Assignee: PANASONIC CORPORATION, Osaka (JP)

(21) Appl. No.: 13/069,137

(22) Filed: Mar. 22, 2011

Related U.S. Application Data
(63) Continuation of application No. PCT/JP2009/004086, filed on Aug. 25, 2009.

(30) Foreign Application Priority Data
Sep. 25, 2008 (JP) 2008-246049

(51) Int. Cl. G06K 9/40

(52) U.S. Cl. 382/260

(57) ABSTRACT

A filter device according to the present invention comprises a filter processing section configured to execute a filtering process of data at arbitrary data positions included in a filtering region, the filtering process having a dependency on a filtering order and the execution per se of the filtering process of at least a part of the data and determine the execution of the filtering process at the arbitrary data positions, and a control section configured to control the filtering process executed by the filter processing section, wherein the control section makes the filter processing section execute the filtering process at a group of first data positions necessary to determine the execution of the filtering process at a second data position which is one of the arbitrary data positions, and the control section makes the filter processing section execute the filtering process at the second data position when the execution determination results obtained by the filter processing section at the group of first data positions are true.

### FIELD OF THE INVENTION

The present invention relates to a filter device and a filter method for filtering images, more particularly to a filter device and a filter method developed for deblock filtering (hereinafter, called DBF) to reduce noises generated in an inter-block boundary when a moving image is encoded and decoded per pixel block.

### BACKGROUND OF THE INVENTION

The entire documents of Japanese patent application No. 2008-246049 filed on Sep. 25, 2008, which include the specification, drawings, and scope of claims, are incorporated herein by reference.

Many of the moving image encoding techniques used these days encode and decode moving images for each block including a plurality of pixel data, wherein the occurrence of noises in an inter-block boundary is an accompanied problem. To solve the problem, DBF is conventionally adopted to reduce the noises generated in the inter-block boundary. Among the DBF methods currently available is, for example, the DBF used in the moving image encoding standard generally called VC-1 introduced by SMPTE (Society of Motion Picture and Television Engineers), wherein restrictions are exercised on a filtering order and execution of a filtering process per se. Referring to a drawing, characteristics of the DBF compliant with VC-1 method are described below.

Referring to FIG. 29, circles drawn in a picture 2901 are pixels. The DBF is a two dimensional filter. The two dimensional filter, DBF, executes a filtering process in the following boundaries by each segment unit 2906:
horizontal boundary 2902 between pixel blocks including 8×8 pixels (hereinafter, called horizontal 8×8 inter-block boundary);
horizontal boundary 2903 between pixel blocks including 8×4 pixels (hereinafter, called horizontal 8×4 inter-block boundary);
vertical boundary 2904 between pixel blocks including 8×8 pixels (hereinafter, called vertical 8×8 vertical inter-block boundary); and
vertical boundary 2905 between pixel blocks including 8×4 pixels (hereinafter, called vertical 8×4 inter-block boundary).

According to VC-1, the DBF executes the filtering process in the following order; horizontal 8×8 inter-block boundary 2902, horizontal 8×4 inter-block boundary 2903, vertical 8×8 inter-block boundary 2904, and vertical 8×4 vertical inter-block boundary 2905. The segment 2906 includes four lines 2907. In the filtering process per line, at least a threshold value and eight pixel data at data positions P1-P8 across the block boundary (see FIG. 29) are referenced to calculate an execution determination result and a filtering operation result. When the execution determination result is true, it is confirmed in the filtering operation result that two pixel data at data positions P4 and P5 across the block boundary illustrated with black circles (see FIG. 29) have been filtered.

In each segment, a line positioned third from the left (top) in all of lines in the segment (hereinafter, called execution determination result arithmetic line) is subjected to the filtering process first, and the calculated execution determination result is used as a decision condition on whether the first, second, and fourth lines are subjected to the filtering process (hereinafter, called execution determination result reference line) (hereinafter, called characteristic 1).

In recent years, a large number of arithmetic stages is used in the Codec to calculate the execution determination result and filtering operation result so that an image quality is improved, and an increasing number of lines are subjected to the filtering process as a pixel count is increasing (hereinafter, called characteristic 2). The other factors of the Codec these days are; a higher processing performance is pursued to encode/decode a high definition moving image, for example, an HD size moving image, and area reduction and lower power consumption are requested so that the Codec can be loaded in a small device such as a mobile telephone.

To mount a filter device qualified to meet the current needs in an image processing device, the characteristics 1 and 2 involve the following problems.

Problem Associated with the Characteristic 1

The execution determination result of the execution determination result arithmetic line has to be calculated before calculating the execution determination result reference line.

Problem Associated with the Characteristic 2

Because of a large number of arithmetic stages, it takes an extensive period of time to calculate the execution determination result and filtering operation result.

Though an effective way to solve these problems is to improve the processing performance by increasing a clock frequency, the increase of the clock frequency leads to an extended arithmetic latency. The extended arithmetic latency deteriorates a throughput, thereby causing the processing performance once improved by the increase of the clock frequency reaches its saturation point. Further, such a large number of lines subjected to the filtering process inevitably increases number of processing cycles necessary for completing the DBF.

A filter device 3000 illustrated in FIG. 30 is conventionally used to solve the problems without any increase of the clock frequency. The filter device 3000 comprises at least a storage device 3001, a filter processing section 3002, and a control section 3003. The storage device 3001 stores therein pixel data required for the filtering process per filtering unit. The filter processing section 3002 receives and filters the pixel data and transmits the filtered pixel data. The control section 3003 controls the storage device 3001 and the filter processing section 3002 so that the filtering process per filtering unit is adequately executed. The filtering unit is a preset unit used in a two dimensional filtering process. FIG. 31 illustrates examples of the filtering unit in VC-1, wherein one of a picture, a macro block (16×16 pixels), and an 8×8 pixel block can be chosen.

[Solution for the Problem Associated with the Characteristic 2 in the Filter Device 3000]

The filter device 3000 reduces the number of processing cycles as described in the following solutions 1 and 2 to solve the problem associated with the characteristic 2. The solution 1 is to execute a pipeline process in the filter processing section 3002 to conceal the arithmetic latency of the filtering operation result so that the number of cycles is reduced. The Patent Document 1 discloses an example of the solution 1, more specifically, disclosing a filter device which pipeline-processes the filtering per 4×4 block in the H.264/AVC DBF.

The solution 2 is to improve a degree of filtering parallelism in the filter processing section 3002 to reduce the number of processing cycles. The Patent Document 2 discloses an example of the solution 2, more specifically, disclosing a filter device which executes the filtering process horizontally and vertically at the same time in the H.264/AVC DBF.

[Solution for the Problem Associated with the Characteristic 1 in the Filter device 3000]

The filter device 3000 solves the problem associated with the characteristic 1 as described in the following solution 3. Describing the solution 3, the control section 3003 speculatively executes the filtering process of the execution determination result reference line, and updates the filtering operation result with a result of the speculatively executed filtering process when the execution determination result of the execution determination result arithmetic line calculated later is true, so that the throughput is prevented from deteriorating.

FIG. 32 illustrates a waveform in the case of no speculative execution (for example, Patent Documents 1 and 2). In a segment 3201, lines 1, 2, 3, and 4 are sequentially filtered in the mentioned order. The filtering order of execution determination result reference lines 2, 3, and 4, which is not defined in VC-1, can be suitably changed. The filter processing section 3002 is executing the pipeline process, wherein arithmetic latencies of the filtering operation result and the execution determination result both have three cycles. Rectangular boxes with numerals N recited therein (N is a natural number) respectively illustrate input of pixel data and output of pixel data/execution determination result in a line N. The control section 3003 transmits suitable control signals, for example, address, to the storage device 3001 so that the pixel data of each line is transmitted and received to and from the storage device 3001 and the filter processing section 3002.

According to a waveform 3202, it is necessary to obtain the execution determination result of an execution determination result arithmetic line 1 before filtering execution determination result arithmetic lines 2, 3, and 4. This triggers stall of the pixel data input equivalent to the execution determination result arithmetic latency (pixel data input to the filter processing section 3002 is suspended).

Referring to FIGS. 33A and 33B is described how the throughput can be prevented from deteriorating by the speculative execution. In FIGS. 33A and 33B, waveforms 3301 and 3302 are waveforms when the execution determination result of the execution determination result arithmetic line 1 in the segment 3201 are true and false, respectively.

In the waveform 3301 wherein it is unnecessary to wait for the execution determination result of the execution determination result arithmetic line 1, the pixel data is inputted to the execution determination result reference lines 2, 3, and 4 in cycles immediately after a cycle in which the pixel data is inputted to the execution determination result arithmetic line 1. Because the execution determination result is true in s cycle in which the execution determination result of the execution determination result arithmetic line 1 is outputted, the pixel data in the storage device 3001 is updated with the outputted pixel data. In cycles thereafter, the pixel data in the storage device 3001 is accordingly updated with the outputted pixel data depending on the execution determination results of the execution determination result reference lines 2, 3, and 4.

In the waveform 3302, the waveform of the pixel data input is similar to that of the waveform 3302. The execution determination result is false in the cycle in which the execution determination result of the execution determination result arithmetic line 1 is outputted. Therefore, the pixel data in the storage device 3001 is not updated with the outputted pixel data. In cycles thereafter, the pixel data in the storage device 3001 is never updated with the outputted pixel data independent of the execution determination results of the execution determination result reference lines 2, 3, and 4. Whenever the filtering process is not executed because of the false execution determination result, the same pixel data as the inputted pixel data may be used as the outputted pixel data to update the pixel data in the storage device 3001. As described so far, the filtering process of the execution determination result reference line is conventionally speculatively executed so that the expected efficiency of the pipeline process is obtained.

### PRIOR ART DOCUMENT

### Patent Documents

Patent Document 1: Unexamined Japanese Patent Applications Laid-Open No. 2006-157925
Patent Document 2: Unexamined Japanese Patent Applications Laid-Open No. 2006-174486

### SUMMARY OF THE INVENTION

### Problem to be Solved by the Invention

In the inventions disclosed in the Patent Documents 1 and 2, wherein the solution 3 to overcome the disadvantage associated with the characteristic 1 is not adopted, the stall of the pixel data input equivalent to the execution determination result arithmetic latency occurs by each segment between the filtering process of the execution determination result arithmetic line and the filtering process of the execution determination result reference line. As a result, the throughput of the pipeline process is deteriorated. In the speculative execution of the filtering process in the execution determination result reference line described in the solution 3, the filtering result obtained from the speculative execution is not needed when the execution determination result of the execution determination result arithmetic line is false. Thus, the processing cycles and power consumed for such a filtering process are wasted.

The present invention provides a filter device and a filter method wherein the efficiency of the pipeline process can be improved.

It is meant by the term, “efficiency”, discussed in this description is to avoid any filtering process in which a result thereby obtained is useless, and any throughput deterioration caused by waiting for the execution result of any filtering process to be completed while there are other filterable lines.

### Means for Solving the Problem

An essential aspect of the present invention is to filter a plurality of execution determination result arithmetic lines first and conceal an execution determination result arithmetic latency by executing a pipeline process. Therefore, a filter device according to the present invention comprises a control section configured to reference an execution determination result after an execution determination result arithmetic line is subjected to a filtering process to determine the execution of the filtering process in an execution determination result reference line, and then execute the filtering process per filtering unit.

The filter device according to the present invention preferably further comprises an execution determination result storage section configured to store therein a plurality of execution determination results calculated in the execution determination result arithmetic lines in addition to the storage device, filter processing section, and control section provided in the conventional filter device. To further provide the execution determination result storage section entails only a minor area increase in a substrate mounted with the structural elements, while providing such an advantage that the efficiency of the pipeline process is improved in the case where the number of execution determination result arithmetic lines subjected to the filtering process first exceeds the execution determination result arithmetic latency.

According to the present invention, the control section preferably controls the filtering process so that all of the execution determination result arithmetic lines in both of first and second dimensional inter-block boundaries are subjected to the filtering process first. According to the technical characteristic, the execution determination result arithmetic latency that can be concealed can be maximized per preset filtering unit so that efficiency of the pipeline process can be further improved. It is necessary that a two dimensional filter used then meets neither of the following conditions.

Condition 1: In the filtering process of the execution determination result arithmetic line in the second dimensional inter-block boundary, pixel data updated in the filtering process of the first dimensional inter-block boundary is referenced.

Condition 2: In the filtering process of the first dimensional inter-block boundary, pixel data updated in the execution determination result arithmetic line of the second dimensional inter-block boundary is referenced.

The filter device according to the present invention preferably further comprises:

at least a storage device configured to store therein data in a filtering region;

a duplication memory configured to store therein the data at a plurality ones of a group of first data positions in a second direction; and

a data selecting section configured to select one of the data stored in the storage device and the data stored in the duplication memory and output the selected data to the filter processing section.

The filter device according to the present invention preferably further comprises:

at least a storage device configured to store therein the data in the filtering region;

a save memory configured to store therein post-filtering data as a result of the filtering process by the filter processing section to the data at the plurality ones of the group of first data positions included in the second direction; and

an output data selecting section configured to select one of the post-filtering data stored in the save memory and a filtering result outputted from the filter processing section. The technical characteristic can increase an applicable scope of the two dimensional filter where the effect of the filter device according to the present invention can exerted exerted with a minor area increase in a substrate mounted with the structural elements. More specifically, the filter device according to the present invention can be effectively used in the case where the two dimensional filter meets the condition 2.

According to the present invention, the filter processing section preferably comprises:

a first filtering section configured to filter data at the group of first data positions; and

a second filtering section configured to filter data at a group of second data positions.

This technical characteristic can achieve a parallel process without reducing the number of cycles that can conceal the execution determination result arithmetic latency, and reduce a storage period and a storage volume of the execution determination results to be stored in the execution determination result storage section.

A filter method according to the present invention is a filter method wherein data at arbitrary data positions included in a filtering region are filtered having a dependency on a filtering order and execution per se of the filtering process of at least a part of the data, comprising:

a first step for executing a filtering process including an execution determination to data at a group of first data positions necessary to determine the execution of the filtering process of data at a second data position which is one of the arbitrary data positions; and

a second step for executing the filtering process of the data at the second data position when a result of the execution determination in the first step is true.

The filter method thus technically characterized can improve the efficiency of the pipeline process.

### Effect of the Invention

The present invention thus technically characterized can conceal the execution determination result arithmetic latency by means of the pipeline process with a minor area increase in a substrate mounted with the structural elements, thereby improving the efficiency of the pipeline process. More specifically, the filter device and the filter method according to the present invention can improve a processing performance as compared to any conventional device and method wherein the speculative execution is not used, and also improve the processing performance as far as none of the execution determination results in all of the segments is true as compared to any conventional device and method wherein the speculative execution is carried out.

The filter device and the filter method according to the present invention configured to dispense with any unnecessary filtering process can lessen power consumption as compared to any conventional device and method wherein the speculative execution is carried out. Further, the filter device and the filter method according to the present invention are technical advantageous in that less processing cycles are executed than in any conventional device and method wherein the speculative execution is carried out. The filter device and the filter method, therefore, can lower the clock frequency when an equal processing time is allowed as compared to any conventional device and method wherein the speculative execution is not used, thereby reducing power consumption.

The other advantageous features of the present invention can maximize the execution determination result arithmetic latency that can be concealed per preset filtering unit, thereby further improving the efficiency of the pipeline process.

The other advantageous features of the present invention can choose to duplicate the pre-filtering pixel data or save the post-filtering pixel data depending on the needs, thereby expanding the applicable scope of the two dimensional filter where the effect of the present invention can be exerted.

The only information stored in the duplication memory and the save memory is the pixel data at the position to be updated in the filtering process of the second dimensional execution determination result arithmetic line. Therefore, the information to be stored in the storage devices is lessened so that an area increase in a substrate mounted with the structural elements can be minimized.

The other advantageous features of the present invention can process the execution determination result arithmetic line and the execution determination result reference line in parallel, thereby enabling the parallel processing without reducing the number of processing cycles that can conceal the execution determination result arithmetic latency.

### BRIEF DESCRIPTION OF THE DRAWINGS

FIG. 1 illustrates a filtering process by a two dimensional filter to which a filter device according to the present invention is applied.

FIG. 2 illustrates examples of a segment in the two dimensional filter to which the filter device according to the present invention is applied.

FIG. 3 is a block diagram illustrating a structural characteristic of a filter device according to an exemplary embodiment 1 of the present invention.

FIG. 4A is a flow chart 1 illustrating a filtering process per filtering unit controlled by a control section 303 of the filter device according to the exemplary embodiment 1.

FIG. 4B is a flow chart 2 illustrating the filtering process per filtering unit controlled by the control section 303 of the filter device according to the exemplary embodiment 1.

FIG. 4C is a flow chart 3 illustrating the filtering process per filtering unit controlled by the control section 303 of the filter device according to the exemplary embodiment 1.

FIG. 5 is a flow chart illustrating a filtering step 401 controlled by the control section 303 of the filter device according to the exemplary embodiment 1.

FIG. 6 is a flow chart illustrating s filtering step 402 controlled by the control section 303 of the filter device according to the exemplary embodiment 1.

FIG. 7 is a flow chart illustrating a filtering step 603 controlled by the control section 303 of the filter device according to the exemplary embodiment 1.

FIG. 8 illustrates a filtering order controlled by the control section 303 in the case where a preceding execution unit in the filter device according to the exemplary embodiment 1 is a single line of an inter-block boundary.

FIG. 9 illustrates a waveform in the case where the filtering order is controlled by the control section 303 of the filter device according to the exemplary embodiment 1 as illustrated in FIG. 8.

FIG. 10 illustrates a filtering order controlled by the control section 303 in the case where the preceding execution unit in the filter device according to the exemplary embodiment 1 includes all of horizontal or vertical inter-block boundaries.

FIG. 11 illustrates a waveform in the case where the filtering order is controlled by the control section 303 of the filter device according to the exemplary embodiment 1 as illustrated in FIG. 10.

FIG. 12 illustrates a filtering order controlled by the control section 303 in the case where the preceding execution unit in the filter device according to the exemplary embodiment 1 includes all of horizontal and vertical inter-block boundaries to be filtered.

FIG. 13 illustrates a waveform in the case where the filtering order is controlled by the control section 303 of the filter device according to the exemplary embodiment 1 as illustrated in FIG. 12.

FIG. 14 illustrates a technical disadvantage of the filter device according to the exemplary embodiment 1.

FIG. 15 is a block diagram illustrating a structural characteristic of a filter device according to an exemplary embodiment 2 of the present invention.

FIG. 16 is a flow chart 1 illustrating a filtering step 401 controlled by a control section 1503 of the filter device according to the exemplary embodiment 2.

FIG. 17 is a flow chart illustrating a filtering step 402 controlled by the control section 1503 of the filter device according to the exemplary embodiment 2.

FIG. 18 is a flow chart illustrating a filtering step 1703 controlled by the control section 1503 of the filter device according to the exemplary embodiment 2.

FIG. 19 illustrates a waveform in the case where a filtering order is controlled by the control section 1503 of the filter device according to the exemplary embodiment 2 as illustrated in FIG. 14.

FIG. 20 is a block diagram illustrating a structural characteristic of a filter device according to an exemplary embodiment 3 of the present invention.

FIG. 21 is a flow chart illustrating a filtering step 401 controlled by a control section 2003 of the filter device according to the exemplary embodiment 3.

FIG. 22 is a flow chart illustrating a filtering step 402 controlled by the control section 2003 of the filter device according to the exemplary embodiment 3.

FIG. 23 is a flow chart illustrating a filtering step 2203 controlled by the control section 2003 of the filter device according to the exemplary embodiment 3.

FIG. 24 illustrates a waveform in the case where a filtering order is controlled by the control section 2003 of the filter device according to the exemplary embodiment 3 as illustrated in FIG. 14.

FIG. 25 illustrates a technical disadvantage of a filter device wherein a degree of parallelism is improved when execution determination result arithmetic lines are filtered based on the exemplary embodiment 1.

FIG. 26 is a block diagram illustrating a structural characteristic of a filter device according to an exemplary embodiment 4 of the present invention.

FIG. 27 illustrates a filtering order is controlled by a control section 2602 of the filter device according to the exemplary embodiment 4

FIG. 28 illustrates a waveform in the case where the filtering order is controlled by the control section 2602 of the filter device according to the exemplary embodiment 4 as illustrated in FIG. 27.

FIG. 29 illustrates characteristics of DBF compliant with VC-1.

FIG. 30 is a block diagram illustrating a structural characteristic of a conventional filter device.

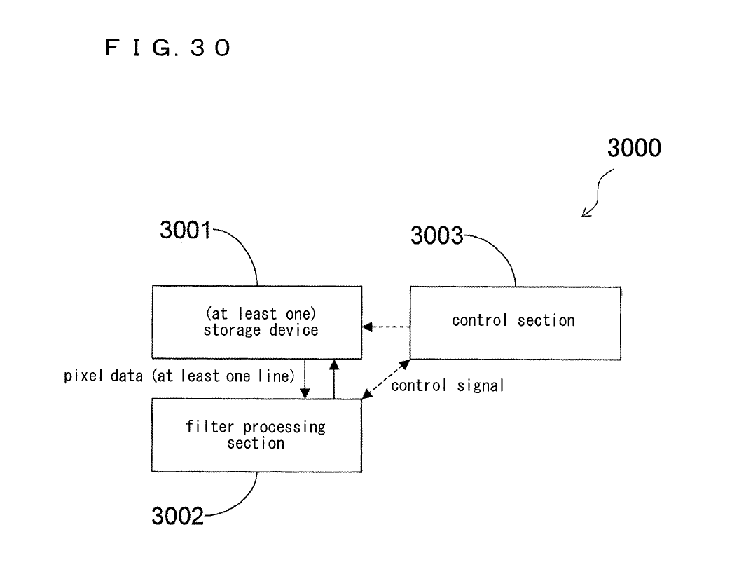

FIG. 31 illustrates examples of a filtering unit compliant with VC-1.

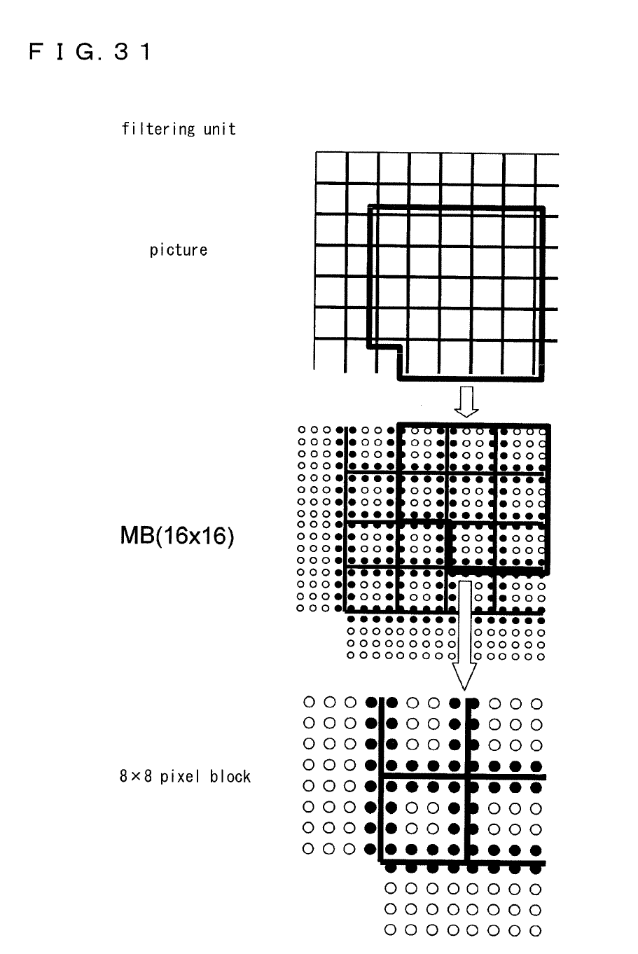

FIG. 32 illustrates a waveform in a VC-1 filtering process according to the methods disclosed in the Patent Documents 1 and 2.

FIG. 33A illustrates a waveform 1 in the VC-1 filtering process in which speculative execution is carried out.

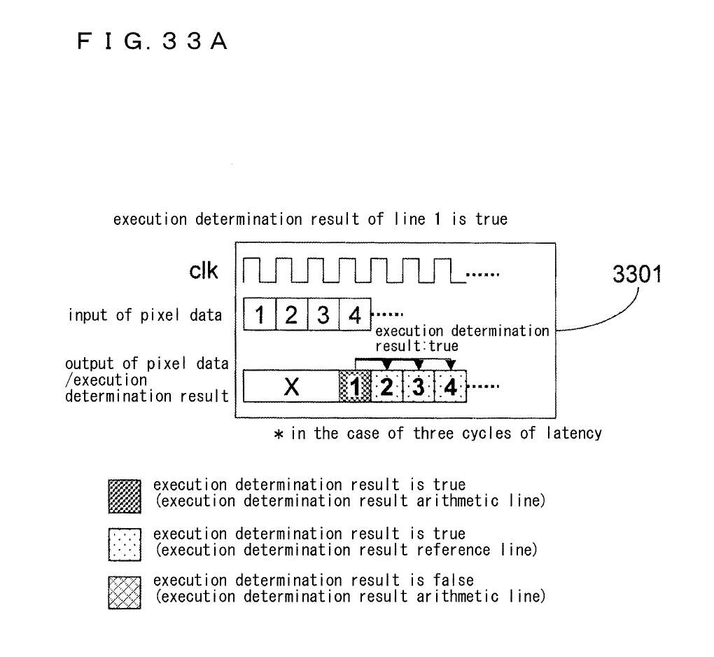

FIG. 33B illustrates a waveform 2 in the VC-1 filtering process in which speculative execution is carried out.

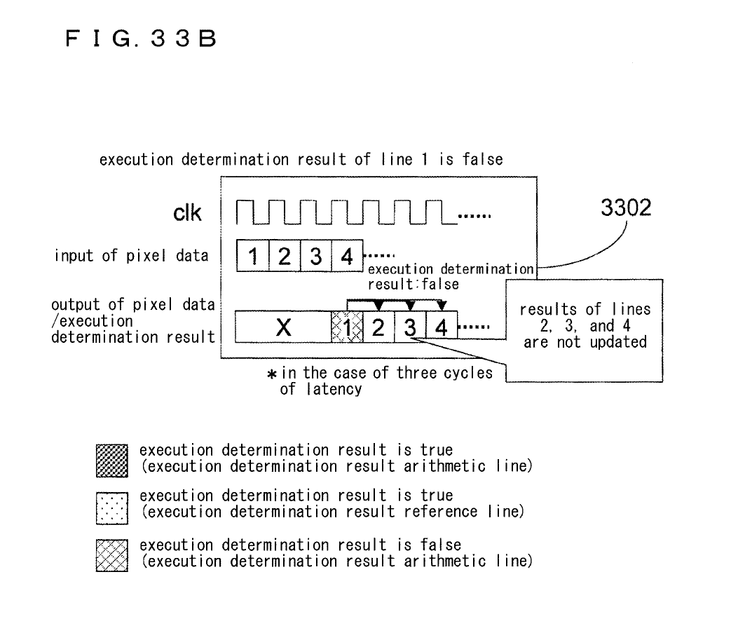

### EXEMPLARY EMBODIMENTS FOR CARRYING OUT THE INVENTION

Before description of exemplary embodiments of the present invention starts, a technical scope is defined for a two-dimensional filter to which the filter device according to the present invention is applied.

[Filtering Order of Inter-Block Boundaries by the Two Dimensional Filter]

Describing the filtering order of inter-block boundaries by the two dimensional filter, first dimensional inter-block boundaries and second dimensional inter-block boundaries may be respectively inter-block boundaries in the horizontal direction and inter-block boundaries in the vertical direction, or vice versa. In the horizontal and vertical directions, the inter-block boundaries may be subjected to the filtering process from left (top), or the inter-block boundary having 8×8 pixels may be subjected to the filtering process first as defined in VC-1.

[Filtering]

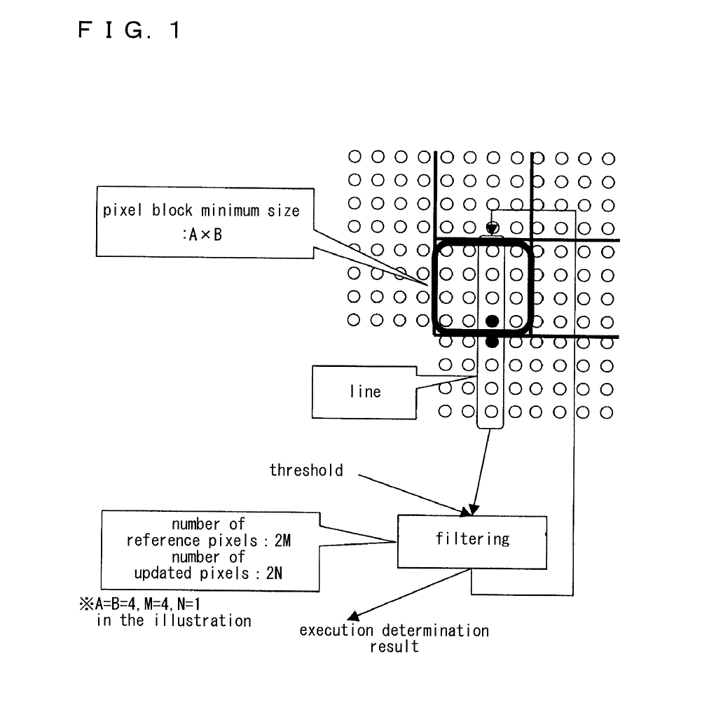

FIG. 1 illustrates a filtering process per line of the inter-block boundaries. In the per-line filtering process, 2M number of pixel data (M is an integral number meeting M>=1) at positions across the inter-block boundaries are referenced (hereinafter, these pixels are called reference pixels, and the pixel data is called reference pixel data), and the reference pixel data is compared to at least a threshold value to calculate an execution determination result. When the calculated execution determination result is true, 2N number of pixel data (N is an integral number meeting 1<=N<=M) at positions across the inter-block boundaries are updated with the filtered pixel data. A minimal interval between the inter-block boundaries subjected to the filtering process is decided based on a minimal size A×B of a pixel block to be encoded (A and B are integral numbers meeting A, B>=1). In the example illustrated in FIG. 1, A=B=4, M=4, N=1.

[Segment]

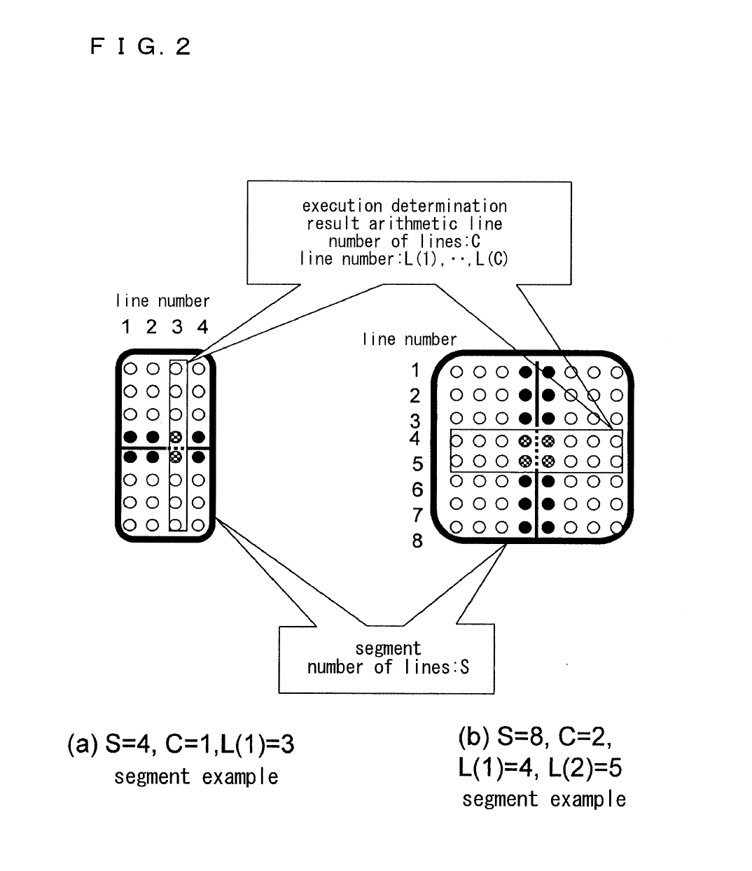

A plurality of lines continuous on the inter-block boundary is collectively called a segment. The number of lines in the segment is called S (S is an integral number meeting S>=1). In examples (a) and (b) of the segment illustrated in FIG. 2, S=4, and S=8, respectively.

[Execution Determination Result Arithmetic Line and Execution Determination Result Reference Line]

In the segment, there is at least an execution determination result arithmetic line, and the other lines are execution determination result reference lines. Describing the execution determination result arithmetic line, an execution determination result calculated in the filtering process of the execution determination result arithmetic line is used to determine the execution of the filtering process in the target segment. The execution determination result arithmetic line includes a first data position. When the execution determination result is true, reference data of the execution determination result arithmetic lines are also updated. The execution determination result reference line is a line where the filtering process is executed in accordance with the execution determination results of the filtering process in the segment where the line is included (obtained in the execution determination result arithmetic line). The execution determination result reference line includes a second data position. When the filtering execution determination result of the segment (obtained in the execution determination result arithmetic line) is true, all of the execution determination result reference lines in the segment are subjected to the filtering process so that the reference data of the execution determination result reference lines are updated.

It is assumed that the execution determination result arithmetic line and the execution determination result reference lines respectively have the equal line numbers in any of the segments. According to VC-1, for example, it is assumed that the execution determination result arithmetic line is the third line, and the execution determination result reference lines are respectively the first, second, and fourth lines in all of the segments. Referring to FIG. 2, the execution determination result arithmetic line and the execution determination result reference line are described. Provided that number of the execution determination result arithmetic lines in the segment is C (C is an integral number meeting 1<=C<S), number of the execution determination result reference lines is S-C. The line numbers of the C number of execution determination result arithmetic lines are L (1), . . . , L (C). In FIG. 2 (a), C=1, L (1)=3. In FIG. 2 (b), C=2, L (1)=4, and L (2)=5.

### Exemplary Embodiment 1

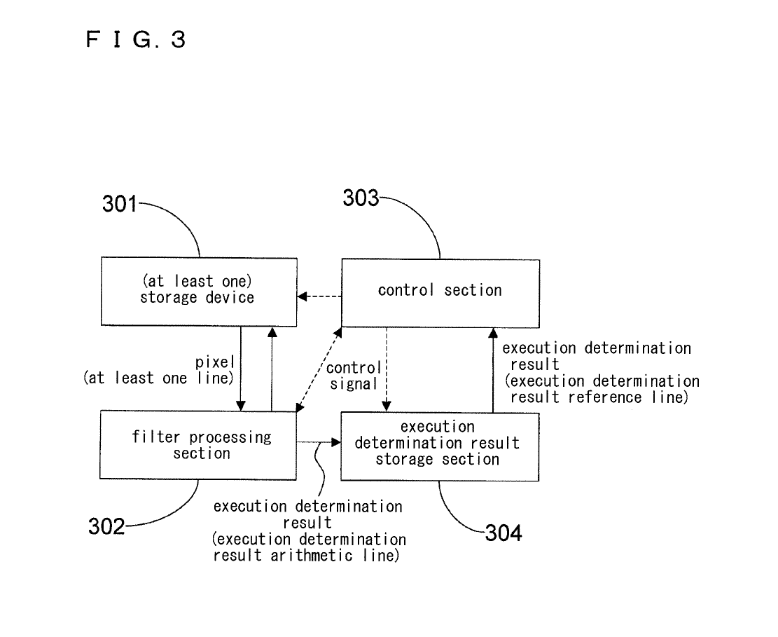

FIG. 3 is a block diagram illustrating a structural characteristic of a filter device according to an exemplary embodiment 1 of the present invention. The filter device according to the exemplary embodiment 1 comprises a storage device 301, a filter processing section 302, a control section 303, and an execution determination result storage section 304.

The execution determination result storage section 304 stores therein a plurality of execution determination results outputted from the filter processing section 302 which filtered pixel data in the execution determination result arithmetic lines (including the first data positions) included in a filtering region. After the filtering process is completed at a plurality of first data positions on the execution determination result arithmetic lines, the control section 303 references the execution determination result received from the execution determination result storage section 304. The control section 303 transmits control signals to the storage device 301 and the execution determination result storage section 304 so that the filtering execution is determined at the second data positions on the execution determination result reference lines based on the referenced execution determination result. The control section 303 further transmits and receives control signals to and from the filter processing section 302. In the description given below, there is only one storage device 301, and the pixel data before and after the filtering process is stored in the same storage space of the storage device 301.

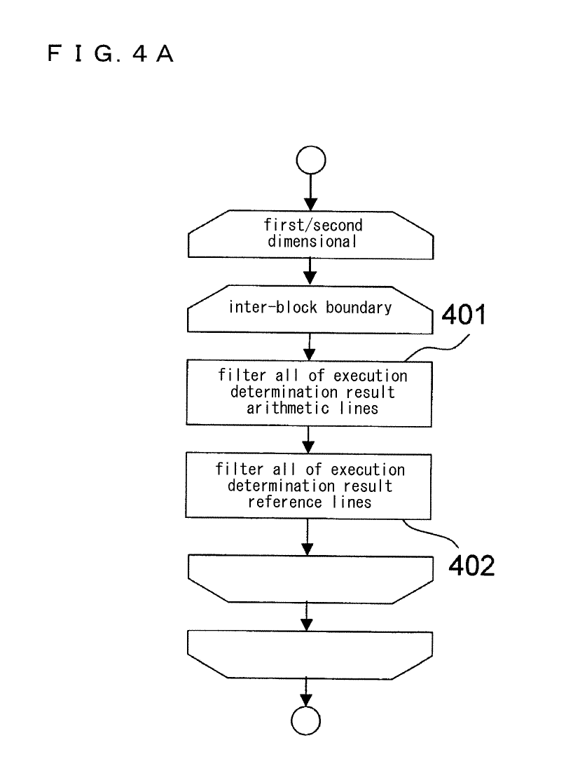

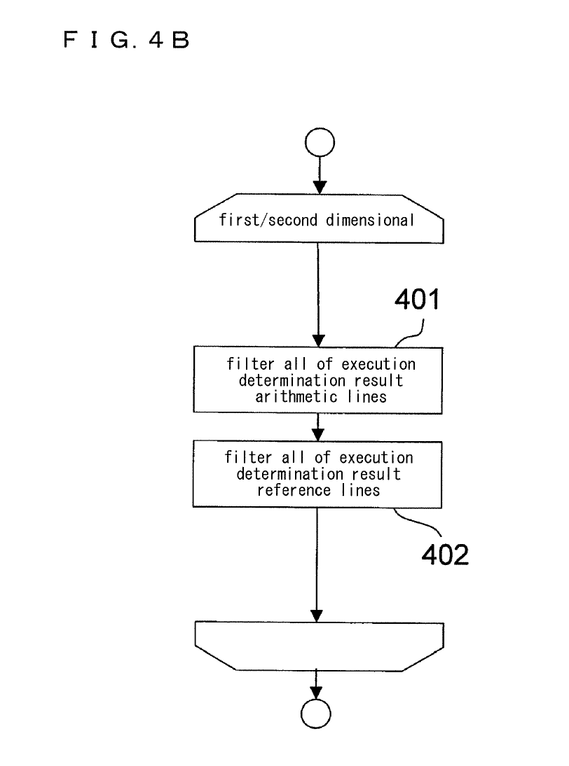

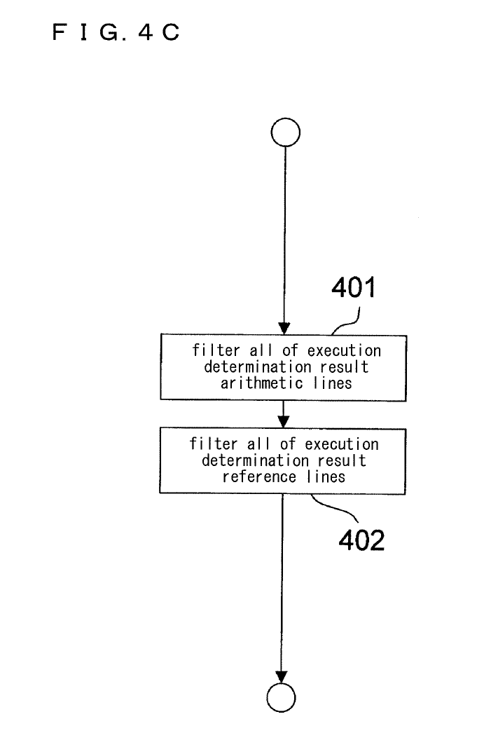

FIGS. 4A-4C are flow charts illustrating a filtering process per filtering unit controlled by the control section 303. These drawings respectively illustrate flow charts (FIGS. 4A-4C) in the case where a unit based on which the execution determination result arithmetic line is subjected to the filtering process first (called preceding execution unit) is:
a single line of an inter-block boundary (FIG. 4A);
all of horizontal or vertical inter-block boundaries (FIG. 4B); and
all of horizontal and vertical inter-block boundaries between adjacent filtering units (FIG. 4C).

In Step 401, all of the execution determination result arithmetic lines, which are targeted for the preceding execution, are subjected to the filtering process. In Step 402, the execution determination result reference lines are subjected to the filtering process which follows the order of the inter-block boundaries defined by the two dimensional filter in all of the segments targeted for the preceding execution depending on the execution determination results of the execution determination result arithmetic lines.

To set the preceding execution unit in all of the horizontal and vertical inter-block boundaries between adjacent filtering units, it is necessary that the two dimensional filter used then meets neither of the following conditions.

Condition 1: In the filtering process of the execution determination result arithmetic line in the second dimensional inter-block boundary, pixel data updated in the filtering process of the first dimensional inter-block boundary is referenced.

Condition 2: In the filtering process of the first dimensional inter-block boundary, pixel data updated in the execution determination result arithmetic line of the second dimensional inter-block boundary is referenced.

In the case where the two dimensional filter meets the condition 1, the filtering process cannot start in the execution determination result arithmetic line of the second dimensional inter-block boundary unless the filtering process is completed in all of the lines of the first dimensional inter-block boundaries. Therefore, the preceding execution unit cannot be set in all of the horizontal and vertical inter-block boundaries between adjacent filtering units.

In the case where the two dimensional filter meets the condition 2, the preceding execution unit similarly cannot be set in all of the horizontal and vertical inter-block boundaries between adjacent filtering units, a reason of which will be described later in an exemplary embodiment 2 of the present invention.

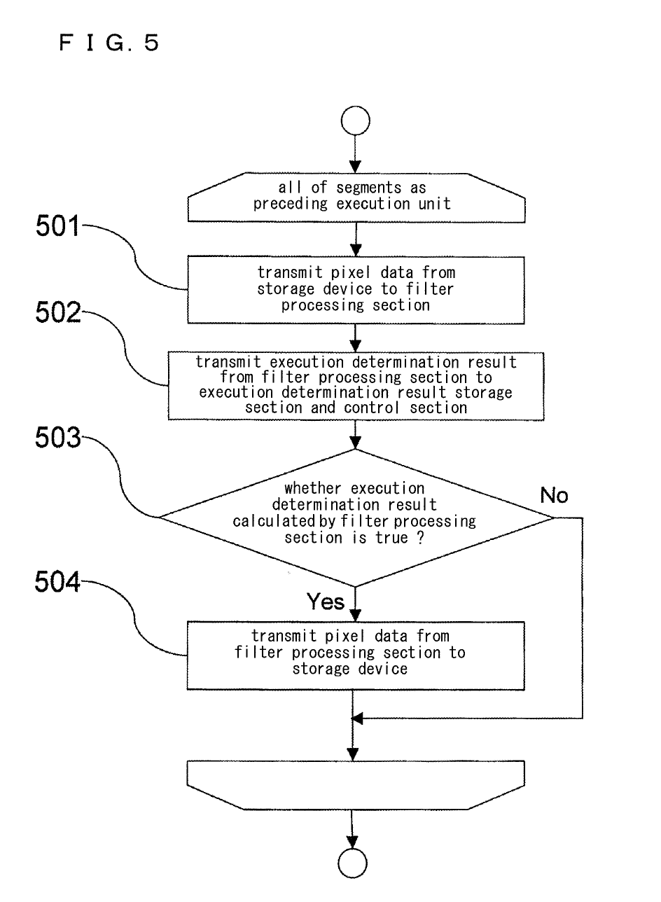

FIG. 5 is a flow chart illustrating the filtering process per preceding execution unit in all of the execution determination result arithmetic lines controlled in Step 402 by the control section 303. In Step 501, pixel data necessary for the filtering process of these lines are transmitted from the storage device 301 to the filter processing section 302. In Step 502, the execution determination results calculated by the filter processing section 302 are transmitted to the control section 303 and the execution determination result storage section 304. The execution determination results of the respective segments per preceding execution unit are stored in different storage spaces of the execution determination result storage section 304. In Step 503, the control section 303 determines whether the execution determination results received from the filter processing section 302 are true. The control section 303 advances to Step 504 when the execution determination results are true, while ending the process without filtering the lines when the execution determination results are false. In Step 504, the pixel data subjected to the filtering operation is transmitted from the filter processing section 302 to the storage device 301.

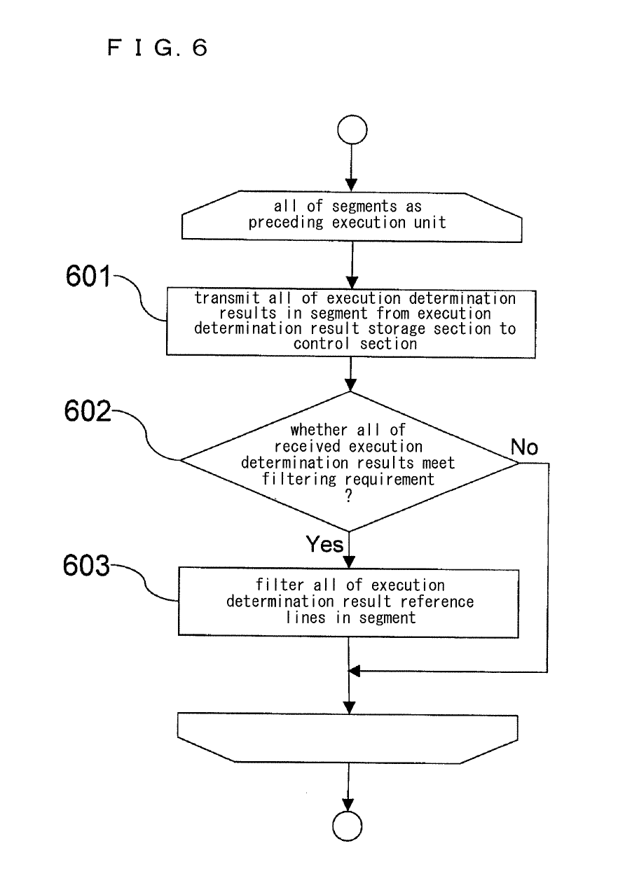

FIG. 6 is a flow chart illustrating the filtering process per preceding execution unit in all of the execution determination result reference lines controlled in Step 402 by the control section 303. In Step 601, the execution determination results of all of the execution determination result arithmetic lines in the target segment are transmitted from the execution determination result storage section 304 to the control section 303. In Step 602, the control section 303 determines whether the received execution determination results of all of the execution determination result arithmetic lines meet a filtering requirement of the target segment. When the control section 303 determines that they meet the requirement, all of the execution determination result reference lines in the segment are subjected to the filtering process in Step 603. When the control section 303 determines that they fail to meet the requirement, the target segment is not subjected to the filtering process, and the process ends.

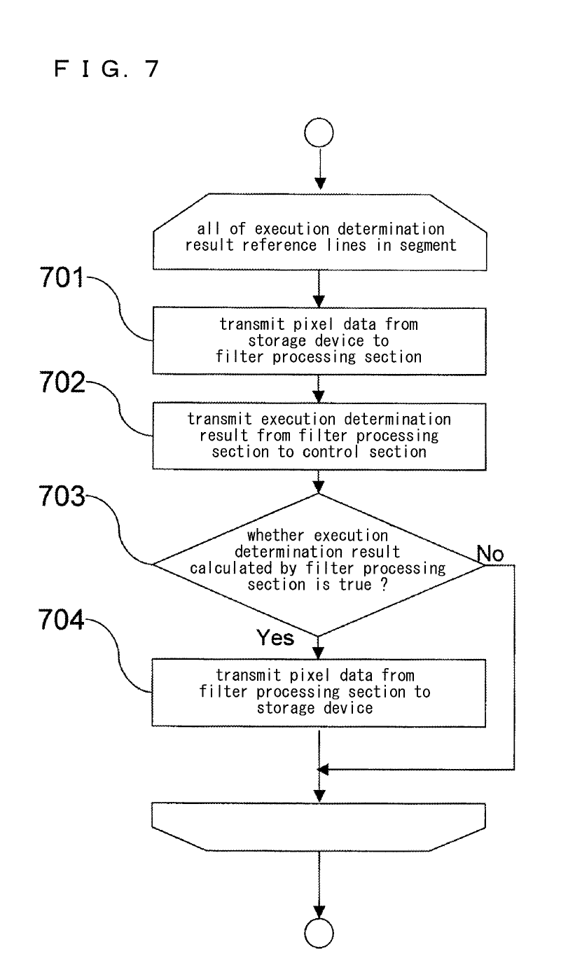

FIG. 7 is a flow chart illustrating the filtering process in all of the execution determination result reference lines in the target segment controlled in Step 603 by the control section 303. In Step 702, the filter processing section 302 transmits the calculated execution determination results to the control section 303. Steps 701, 703, and 704 are respectively similar to Steps 501, 503, and 504.

Hereinafter, the operation of the filter device according to the present exemplary embodiment 1 is described referring to an example in which the applied two dimensional filter is defined as follows.
filtering unit: macro block
filtering order: vertical>=horizontal, starting from left or top inter-block boundary
other parameters: M=1, N=1, B=4, A=1, L (1)=2

The two dimensional filter meets neither of the condition 1 nor 2, and the requirement for filtering the target segment is that the execution determination results in all of the execution determination result arithmetic lines in the target segment are true.

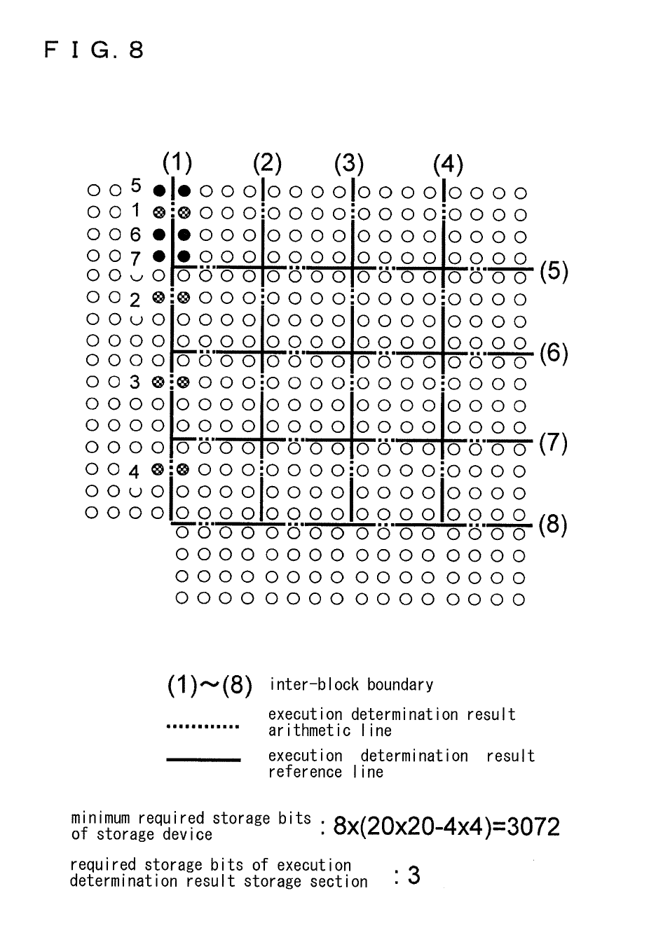

To filter brightness components in the case where the preceding execution unit is a single line in the inter-block boundary, the control section 303 outputs the control signal so that the filtering process which follows a processing order illustrated in, for example, FIG. 8 is executed. All of numerals illustrated near the pixels to be updated by the filtering process are ordinal numbers representing the filtering order. First, the execution determination result arithmetic lines (1^{st}-4^{th} lines) of four segments in an inter-block boundary (1) are subjected to the filtering process. Then, the execution determination result reference lines (5^{th}-16^{th} lines) of four segments are subjected to the filtering process depending on the execution determination results of the execution determination result arithmetic lines. The 8^{th}-16^{th} lines in the respective segments not illustrated in the drawing are subjected to the filtering process in the same filtering order as the 5^{th}-7^{th} lines, and inter-block boundaries (2)-(8) are similarly subjected to the filtering process.

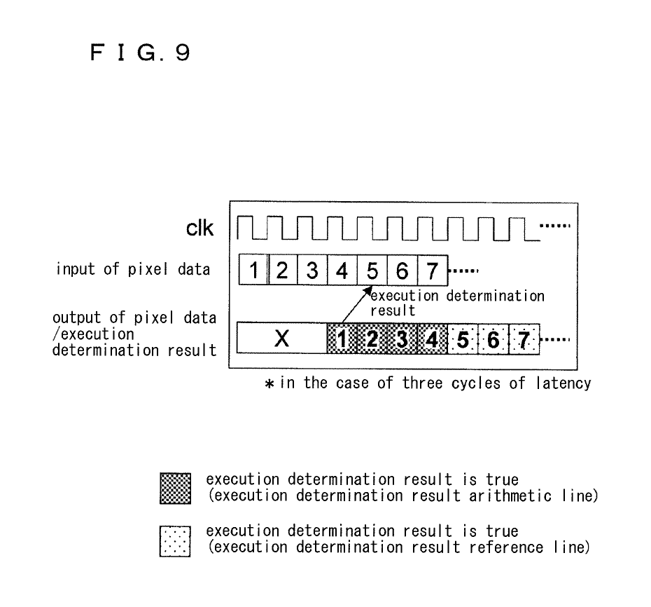

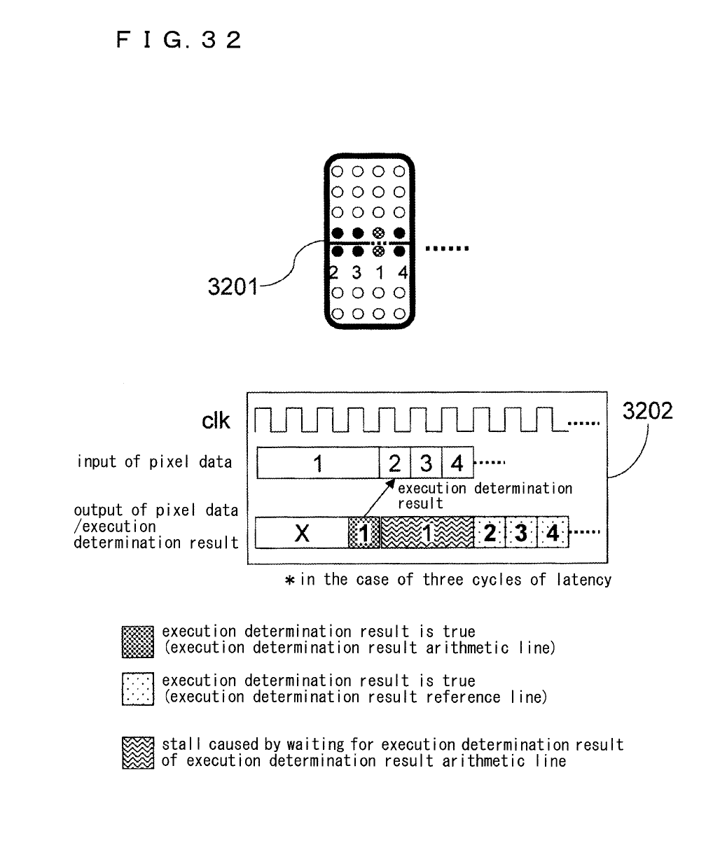

FIG. 9 illustrates a waveform when the filtering process which follows the processing order illustrated in FIG. 8 is executed, wherein latency are similar to FIG. 32. The execution determination result of the execution determination result arithmetic line 1 is calculated in an earlier cycle than the filtering process of the execution determination result reference lines 5-7 in the same segment, which prevents the throughput of the pipeline process from deteriorating. Further, three cycles of the execution determination result arithmetic latency are concealed by the pipeline process.

It is necessary for the storage device 301 to store therein at least pixel data necessary for the filtering process per filtering unit. One pixel data has eight bits, therefore, a minimum required storage bits is 8×(20×20−4×4)=3072. While four execution determination results are written in the waveform illustration of FIG. 9, one execution determination result is read, therefore, number of storage bits of the execution determination result storage section 304 is 4−1=3.

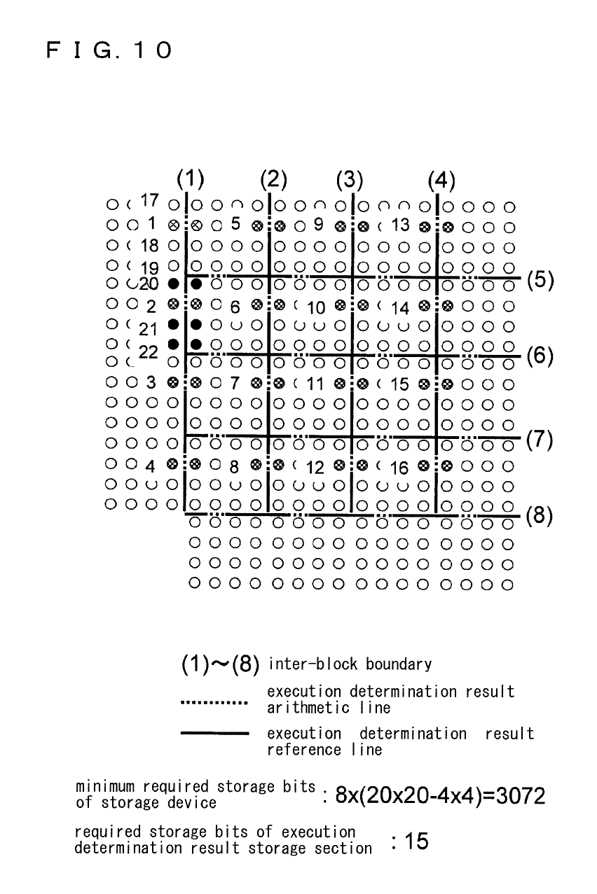

To filter brightness components in the case where the preceding execution unit is set in all of the horizontal or vertical inter-block boundaries between adjacent filtering units, the control section 303 outputs the control signal so that the filtering process which follows a processing order illustrated in, for example, FIG. 10 is executed. First, the execution determination result arithmetic lines (1^{st}-4th lines) of 16 segments in inter-block boundaries (1)-(4) are subjected to the filtering process. Then, the execution determination result reference lines of 16 segments (17^{th}-64^{th} lines) are subjected to the filtering process depending on the execution determination results of the execution determination result arithmetic lines. The 20^{th}-64^{th} lines in the respective segments not illustrated in the drawing are subjected to the filtering process in the same filtering order as the 17^{th}-19^{th} lines, and inter-block boundaries (5)-(8) are similarly subjected to the filtering process.

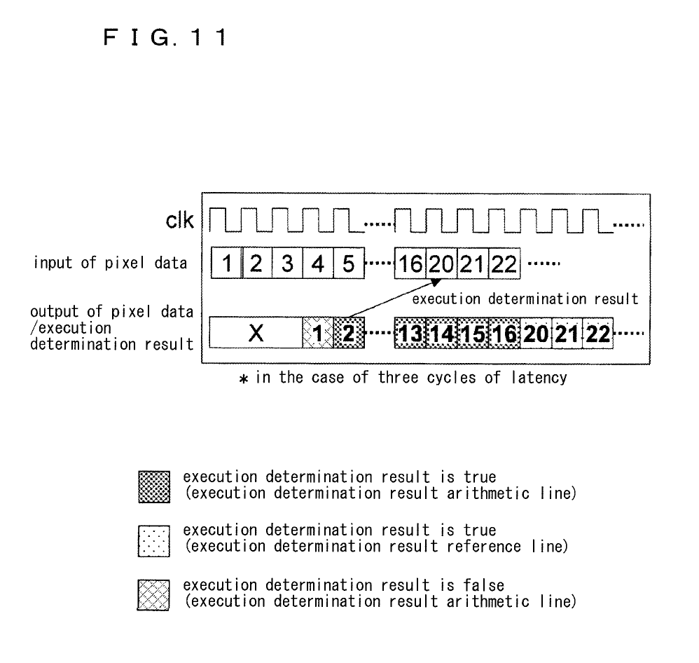

FIG. 11 illustrates a waveform when the filtering process which follows the processing order illustrated in FIG. 10 is executed, wherein latency are similar to FIG. 32. In this example, the execution determination result of the execution determination result arithmetic line 1 is false, whereas the execution determination result of the execution determination result arithmetic line 2 is true. Then, the execution determination result reference lines 17-19 in the same segment are skipped to save processing time and power. The execution determination result of the execution determination result arithmetic line 2 is calculated in an earlier cycle than the filtering process of the execution determination result reference lines 20-22 in the same segment, which prevents the throughput of the pipeline process from deteriorating. Further, 15 cycles of the execution determination result arithmetic latency are concealed by the pipeline process.

Since the macro block is set as the filtering unit, the minimum required number of storage bits of the storage device 301 is 3072. While 16 execution determination results are written in the waveform illustration of FIG. 11, one execution determination result is read, therefore, number of storage bits of the execution determination result storage section 304 is 16−1=15.

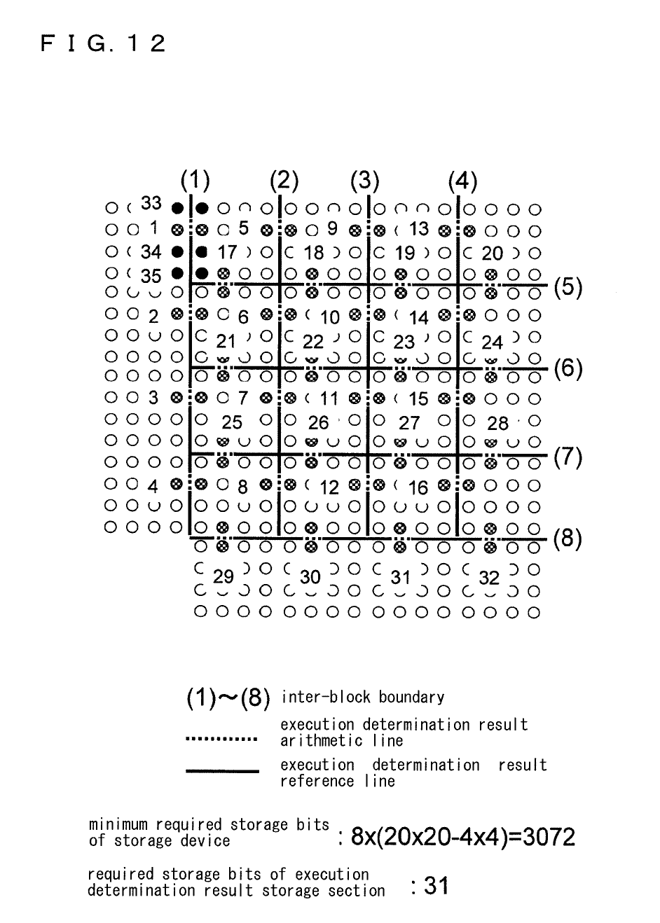

To filter brightness components in the case where the preceding execution unit is set in all of the horizontal and vertical inter-block boundaries between adjacent filtering units, the control section 303 outputs the control signal so that the filtering process which follows a processing order illustrated in, for example, FIG. 12 is executed. First, the execution determination result arithmetic lines (1^{st}-32^{nd} lines) of 32 segments in inter-block boundaries (1)-(8) are subjected to the filtering process. Then, the execution determination result reference lines of 16 segments (33^{rd}-128^{th} lines) of 32 segments are subjected to the filtering process depending on the execution determination results of the execution determination result arithmetic lines. The 36^{th}-128^{th} lines in the respective segments not illustrated in the drawing are subjected to the filtering process in the same filtering order as the 33^{rd}-35^{th} lines.

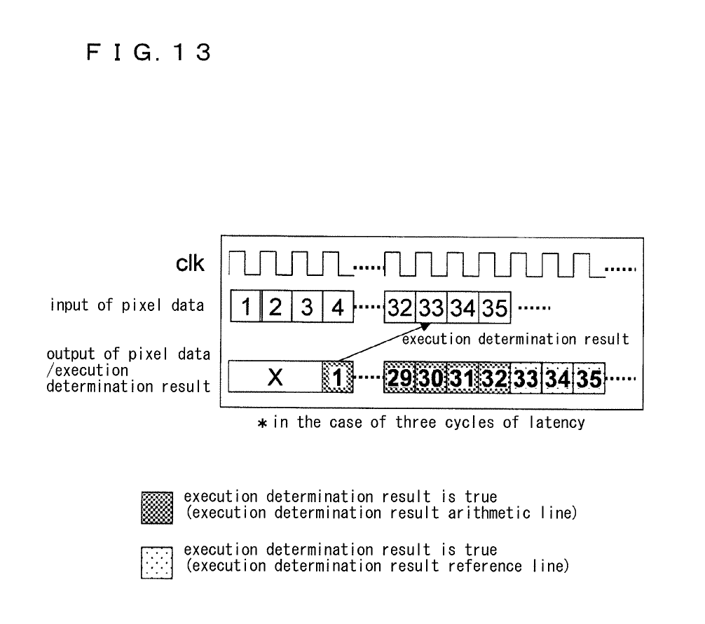

FIG. 13 illustrates a waveform when the filtering process which follows the processing order illustrated in FIG. 12 is executed, wherein latency are similar to FIG. 32. The execution determination result of the execution determination result arithmetic line 1 is calculated in an earlier cycle than the filtering process of the execution determination result reference lines 33-35 in the same segment, which prevents the throughput of the pipeline process from deteriorating. Further, 31 cycles of the execution determination result arithmetic latency are concealed by the pipeline process.

Since the macro block is set as the filtering unit, the minimum required number of storage bits of the storage device 301 is 3072. While 32 execution determination results are written in the waveform illustration of FIG. 11, one execution determination result is read, therefore number of storage bits of the execution determination result storage section 304 is 32−1=31.

As described so far, the filter device according to the exemplary embodiment 1 is technically advantageous in that a plurality of execution determination result arithmetic lines are subjected to the filtering process first, so that the execution determination result arithmetic latency can be concealed by the pipeline process. Therefore, the throughput is prevented from deteriorating as far as the number of execution determination result arithmetic lines to be subjected to the filtering process beforehand exceeds the execution determination result arithmetic latency. In the case where the execution determination result of the execution determination result arithmetic line in the target segment is false, the filtering process of the execution determination result reference lines in the target segment can be skipped to save processing time and labor. When the preceding execution unit is set in all of the horizontal and vertical inter-block boundaries between adjacent filtering units, the number of cycles that can conceal the execution determination result arithmetic latency can be maximized, so that the throughput deterioration can be more effectively prevented. The only information stored in the execution determination result storage section is the execution determination result of the execution determination result arithmetic line, which is less than the information stored in the storage device. As a result, an area increase by the execution determination result storage section further provided in a substrate mounted with the structural elements is minimized.

### Exemplary Embodiment 2

In the filter device according to the exemplary embodiment 1, the preceding execution unit cannot be set in all of the horizontal and vertical inter-block boundaries between adjacent filtering units in the case where the condition 2 is met by the two dimensional filter. The VC-1 is a two dimensional filter which meets the condition 2. Therefore, it comes with the disadvantage to apply the present invention to VC-1.

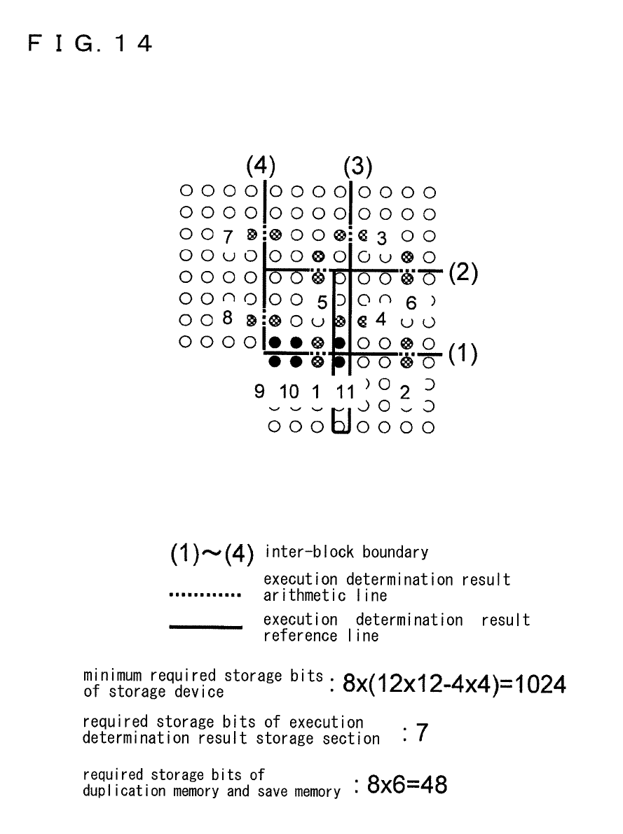

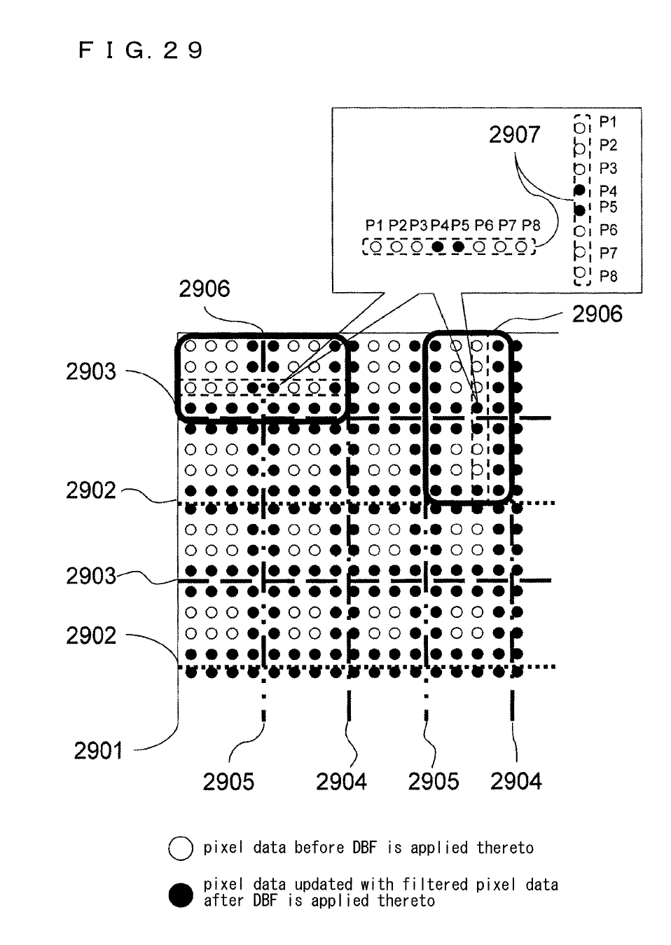

The disadvantage is further described referring to FIG. 14. FIG. 14 is an example in which VC-1 is applied to the filter device according to the exemplary embodiment 1 wherein the filtering unit is an 8×8 pixel block. In the example, eight pixels across the inter-block boundaries are referenced in the filtering process of the execution determination result reference line 11, and the pixel data at the data position P3 (see FIG. 29) is already filtered in the execution determination result arithmetic line 4. The two dimensional filter, however, is configured to filter the second dimensional boundaries after the first dimensional boundaries. As far as the two dimensional filter meets the condition 2, it is not possible to set the preceding execution unit in all of the horizontal and vertical inter-block boundaries between adjacent filtering units in the filter device according to the exemplary embodiment 1.

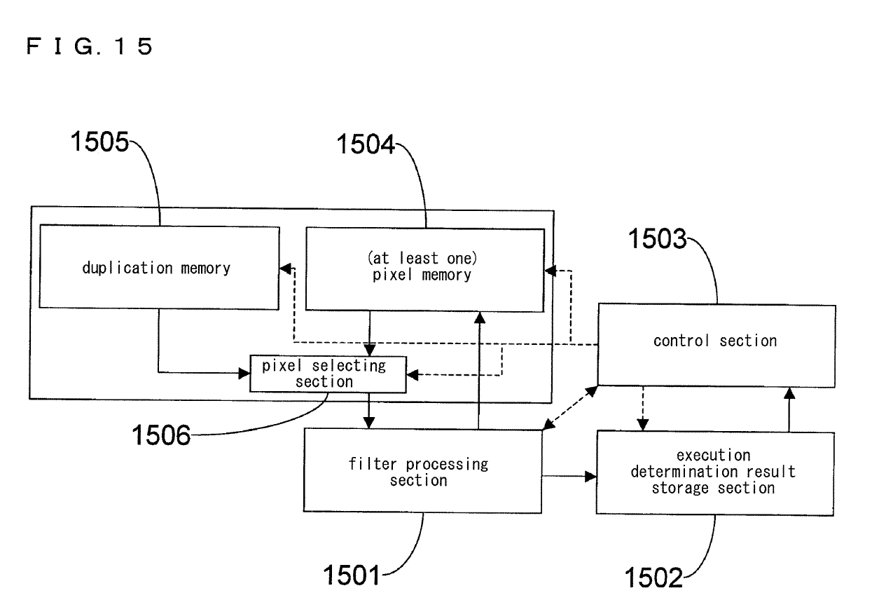

The disadvantage when the present invention is applied to VC-1 was so far described. Referring to FIG. 15 is described a filter device according to an exemplary embodiment 2 of the present invention in which the disadvantage has been overcome. The filter device according to the exemplary embodiment 2 comprises a filter processing section 1501, an execution determination result storage section 1502, a control section 1503, a pixel memory 1504, a duplication memory 1505, and a pixel selecting section 1506. The pixel memory 1054 stores therein pixel data of a part of or all of images. The duplication memory 1504 stores therein 2N number of pre-filtering pixel data updated in the execution determination result arithmetic lines of the second dimensional inter-block boundary (hereinafter, called first lines). The pixel selecting section 1506 selects the pixel data of the duplication memory 1505 when referencing the pixel data at 2N number of data positions updated in the first lines in the filtering process of the first dimensional inter-block boundary, and selects the pixel data of the pixel memory 1504 when referencing the pixel data at any other data positions. The control section 1503 transmits control signals to the pixel memory 1504, duplication memory 1505, pixel selecting section 1506, and execution determination result storage section 1502 so that the execution determination results received from the execution determination result storage section 1502 are referenced after the filtering process of a plurality of execution determination result arithmetic lines is completed to determine the execution of the filtering process in the execution determination result reference lines. Apart from these control signals, the control section 1503 further transmits and receives a control signal for the execution determination to and from the filter processing section 1501. In the description given below, there is only one pixel memory 1504, and the pixel data before and after the filtering process is stored in the same storage space of the pixel memory 1504.

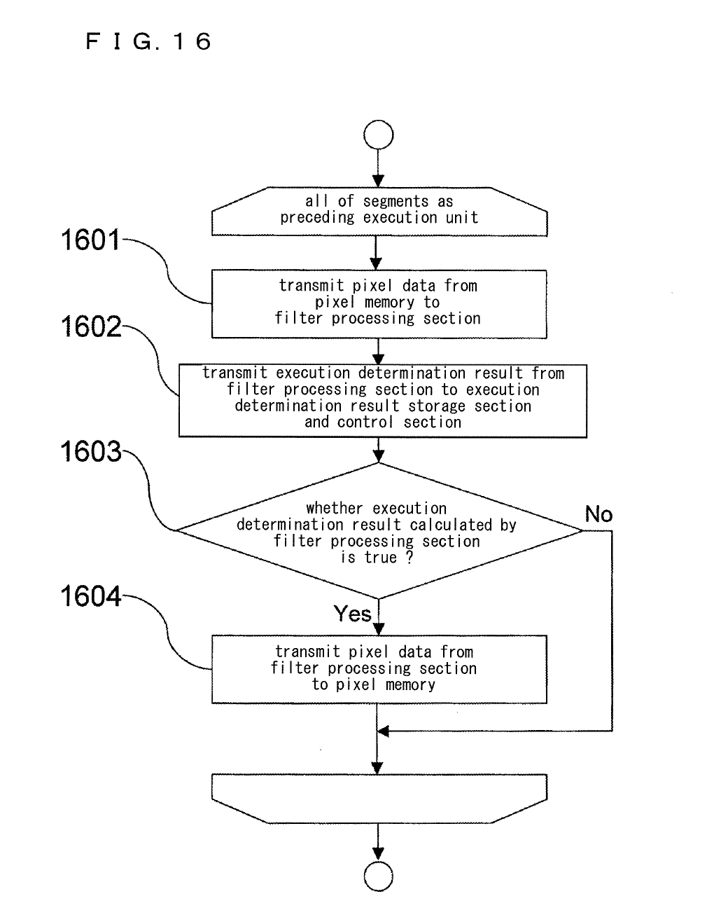

A filtering flow per filtering unit controlled by the control section 1503 is similar to the flow illustrated in FIG. 4C. FIG. 16 is a flow chart illustrating the filtering process per preceding execution unit in all of the execution determination result arithmetic lines controlled in Step 401 by the control section 1503. In Step 1601, the pixel selecting section 1506 selects all of the pixel data necessary for the filtering process of these lines from the pixel memory 1504 and transmits the obtained pixel data to the filter processing section 1501. In Step 1602, the filter processing section 1501 determines whether the filtering process is executed based on the inputted pixel data, and transmits the calculated execution determination results to the control section 1503 and the execution determination result storage section 1502. In Step 1603, the control section 1503 determines whether the execution determination results received from the filter processing section 1501 are true. The control section 1503 proceeds to Step 1604 when the execution determination results are true, while ending the process when the execution determination results are false without executing the filtering process. In Step 1604, the filter processing section 1501 executes the filtering process of the target lines and transmits the filtered pixel data to the pixel memory 1504.

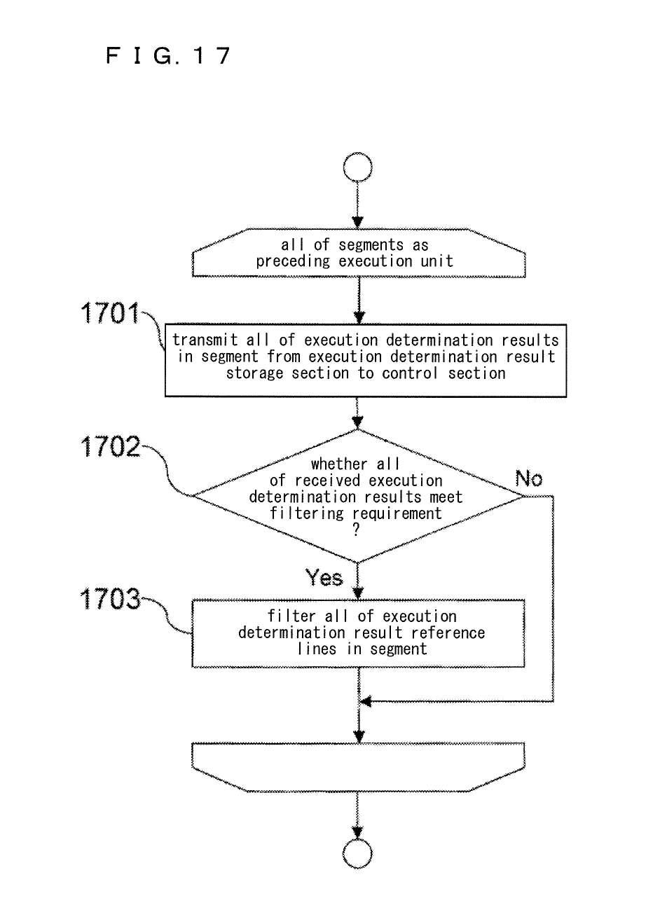

FIG. 17 is a flow chart illustrating the filtering process per preceding execution unit of all of the execution determination result reference lines controlled in Step 402 by the control section 1503. In Step 1701, the execution determination result storage section 1502 transmits the execution determination results of all of the execution determination result arithmetic lines in the target segment to the control section 1503. In Step 1702, the control section 1503 determines whether the received execution determination results of all of the execution determination result arithmetic lines meet a filtering requirement of the target segment. The filter processing section 1501 executes the filtering process of the reference lines in Step 1703 when the control section 1503 determines in Step 1702 that the filtering requirement is met. The filtering process is omitted for the segment and then ends when the control section 1503 determines that the filtering requirement is not met.

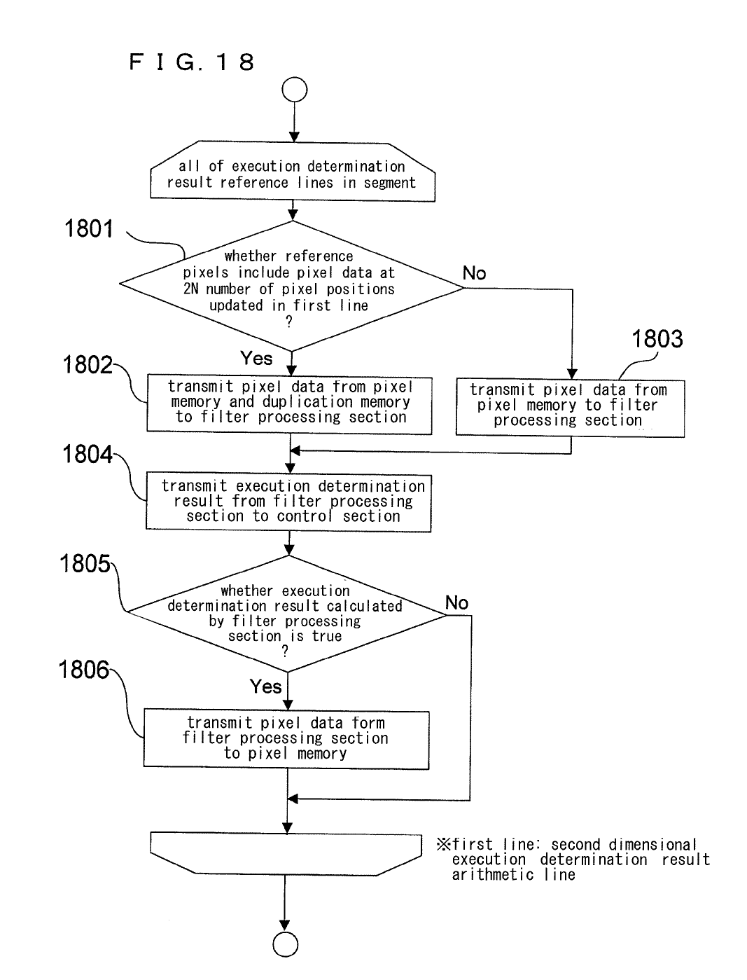

FIG. 18 is a flow chart illustrating the filtering process of all of the execution determination result reference lines in the target segment controlled in Step 1703 by the control section 1503. In Step 1801, the control section 1503 determines whether the reference pixels include the pixel data at 2N number of data positions updated in the first lines. The process proceeds to Step 1802 when the control section 1503 determines that the pixel data is included therein, while proceeding to Step 1803 when determined otherwise. In Step 1802, the pixel selecting section 1506 selects a group of pixel data at 2N number of data positions updated in the first lines in all of the pixel data necessary for filtering the target lines from the duplication memory 1505, while selecting the other pixel data from the pixel memory 1504. Then, the pixel selecting section 1506 transmits the selected pixel data to the filter processing section 1501. In Step 1804, the execution determination results obtained by the filter processing section 1501 are transmitted to the control section 1503. Steps 1803, 1805, and 1806 are respectively similar to Steps 1601, 1603, and 1604.

Hereinafter, the operation of the filter device according to the present exemplary embodiment 2 is described referring to an example in which the applied two dimensional filter is defined as follows.
filtering unit: pixel block including 8×8 pixels
filtering order: horizontal>=vertical, starting from inter-block boundary including 8×8 pixels
other parameters: M=4, N=1, B=4, A=1, L (1)=3

The two dimensional filter meets the condition 2, and the requirement for filtering the target segment is that the execution determination results in all of the execution determination result arithmetic lines in the segment are true.

To filter brightness components, the control section 1503 outputs the control signal so that the execution determination result arithmetic lines (1^{st}-8^{th} lines) of eight segments in the inter-block boundaries (1)-(4) are subjected to the filtering process as illustrated in FIG. 14. Then, the execution determination result reference lines of eight segments (9^{th}-32^{nd} lines) are subjected to the filtering process depending on the execution determination results of the execution determination result arithmetic lines. The 12^{th}-32^{nd} lines in the respective segments not illustrated in the drawing are subjected to the filtering process in the same filtering order as the 9^{th}-11^{th} lines.

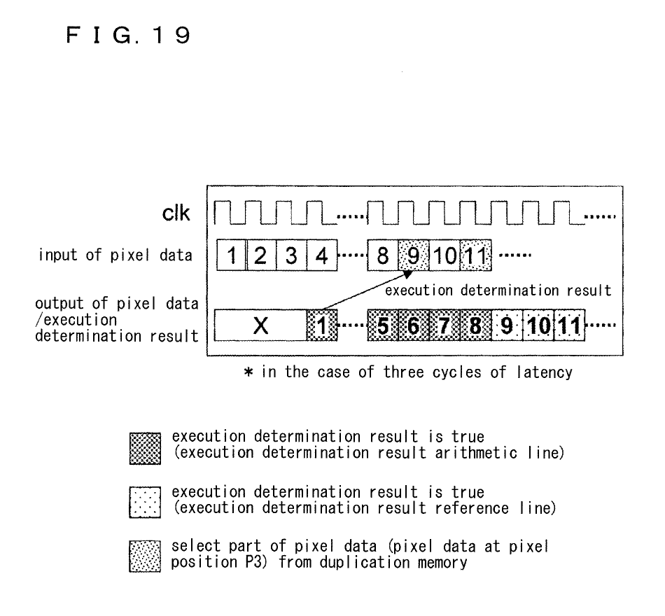

FIG. 19 illustrates a waveform when the filtering process which follows a processing order illustrated in FIG. 14 is executed, wherein latency are similar to FIG. 32. The execution determination result of the execution determination result arithmetic line 1 is calculated in an earlier cycle than the filtering process of the execution determination result reference lines 9-11 in the same segment, which prevents the throughput of the pipeline process from deteriorating. In the filtering process of the lines 9 and 11 (including the pixel data at data positions updated in the first lines as the reference pixels) of the first dimensional inter-block boundary, the pixel selecting section 1506 selects the pixel data from the duplication memory 1505 as the pixel data at the data position P3 (see FIG. 29), whiles selecting the pixel data at any other positions from the pixel memory 1504. Then, the pixel selecting section 1506 transmits the selected pixel data to the filter processing section 1501. Therefore, when the preceding execution unit is set in all of the horizontal and vertical inter-block boundaries between adjacent filtering units, an image thereby obtained is similar to that of the filtering process which follows a standard filtering process.

The filtering unit is an 8×8 pixel block. Therefore, the minimum required number of storage bits of the pixel memory 1504 is 8×(12×12−4×4)=1024. While eight execution determination results are written in the waveform illustration of FIG. 19, one execution determination result is read, therefore, number of storage bits of the execution determination result storage section 1502 is 8−1=7. Because the pixel data at the data positions P4 and P5 in the first lines (see FIG. 29) and the pixel data at data positions P7 and P8 in the first lines (see FIG. 29) are stored in the duplication memory 1505, the number of bits thereof is 8×6=48.

In the filter device according to the exemplary embodiment 2, the preceding execution unit can be set in all of the horizontal and vertical inter-block boundaries between adjacent filtering units although the applied two dimensional filter meets the condition 2. The only pixel data stored in the duplication memory 1505 is 2N number of pixel data updated in the first lines. Therefore, an area increase in a substrate mounted with the structural elements is minimized.

### Exemplary Embodiment 3

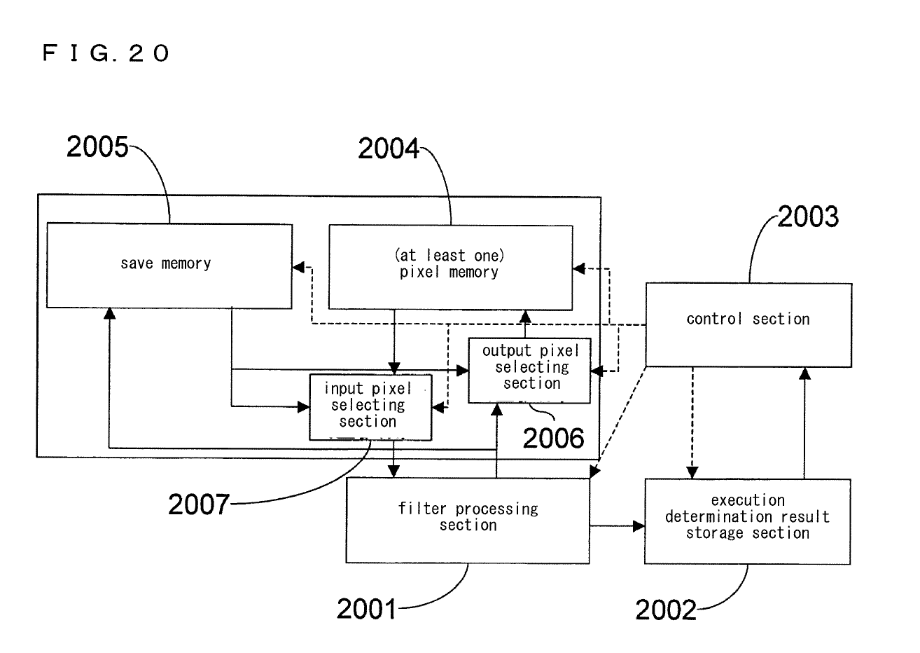

A filter device according to an exemplary embodiment 3 of the present invention differently overcomes the disadvantage described in the exemplary embodiment 2. The filter device is structurally characterized as illustrated in FIG. 20. The filter device according to the exemplary embodiment 3 comprises a filter processing section 2001, an execution determination result storage section 2002, a pixel memory 2004, a control section 2003, a save memory 2005, an output pixel selecting section 2006, and an input pixel selecting section 2007.

The save memory 2005 stores therein 2N number of post-filtering pixel data updated in the first lines. In the filtering process of the first dimensional inter-block boundary, the output pixel selecting section 2006 selects the pixel data supplied from the save memory 2005 to update the pixel data at 2N number of data positions updated in the first lines, and selects the pixel data supplied from the filter processing section 2001 to update the pixel data at any other data positions. In the filtering process of the first lines, the input pixel selecting section 2007 selects the pixel data supplied from the save memory 2005 to reference the pixel data at 2N number of data positions updated in the adjacent inter-block boundary, and selects the pixel data supplied from the pixel memory 2004 to reference any other pixel data. The control section 2003 transmits control signals to the pixel memory 2004, save memory 2005, output pixel selecting section 2006, input pixel selecting section 2007, and execution determination result storage section 2002 to determine the execution of the filtering process in the execution determination result reference lines by referencing the execution determination results received from the execution determination result storage section 2002 after a plurality of execution determination result arithmetic lines are subjected to the filtering process. The control section 2003 further transmits and receives a control signal to and from the filter processing section 2001 to determine the execution. In the description given below, there is only one pixel memory 2004, and the pixel data before and after the filtering process is stored in the same storage space of the pixel memory 2004. A filtering flow per filtering unit controlled by the control section 2003 is similar to the flow illustrated in FIG. 4C.

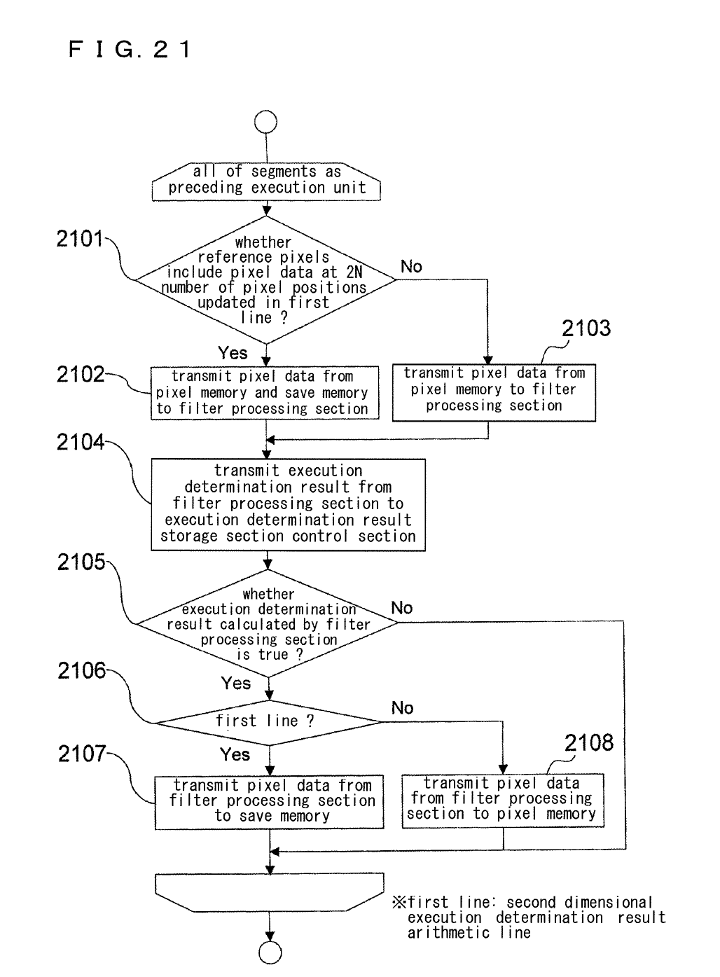

FIG. 21 is a flow chart illustrating the filtering process per preceding execution unit in all of the execution determination result arithmetic lines controlled in Step 401 by the control section 2003. In Step 2101, the control section 2003 determines whether the reference pixels include the pixel data at 2N number of data positions updated in the first lines. The process proceeds to Step 2102 when the control section 2003 determines that the pixel data is included therein, while proceeding to Step 2103 when determined otherwise. In Step 2102, the input pixel selecting section 2007 selects a group of pixel data at 2N number of data positions updated in the first lines in all of the pixel data necessary for filtering the target lines from the save memory 2005, while selecting the other pixel data from the pixel memory 2004. The input pixel selecting section 2007 transmits the selected pixel data to the filter processing section 2001. In Step 2103, the input pixel selecting section 2007 selects all of the pixel data necessary for filtering the target lines from the pixel memory 2004 and transmits the selected pixel data to the filter processing section 2001. In Step 2104, the execution determination results obtained by the filter processing section 2001 are transmitted to the control section 2003 and the execution determination result storage section 2002. In Step 2105, the control section 2003 determines whether the execution determination results received from the filter processing section 2001 are true. The control section 2003 advances to Step 2106 when the execution determination results are true, while ending the process without executing the filtering process for the target lines when the execution determination results are false. In Step 2106, the control section 2003 determines whether the target lines are the first lines. The process advances to Step 2107 when the control section 2003 determines that the target lines are the first lines, while advancing to Step 2108 when it is determined that the target lines are any lines but the first lines. In Step 2107, the filter processing section 2001 transmits the filtered pixel data to the save memory 2005. In Step 2108, the output pixel selecting section 2006 selects all of the pixel data necessary for filtering the target lines from all of the filtered pixel data outputted from the filter processing section 2001 and transmits the selected pixel data to the pixel memory 2004.

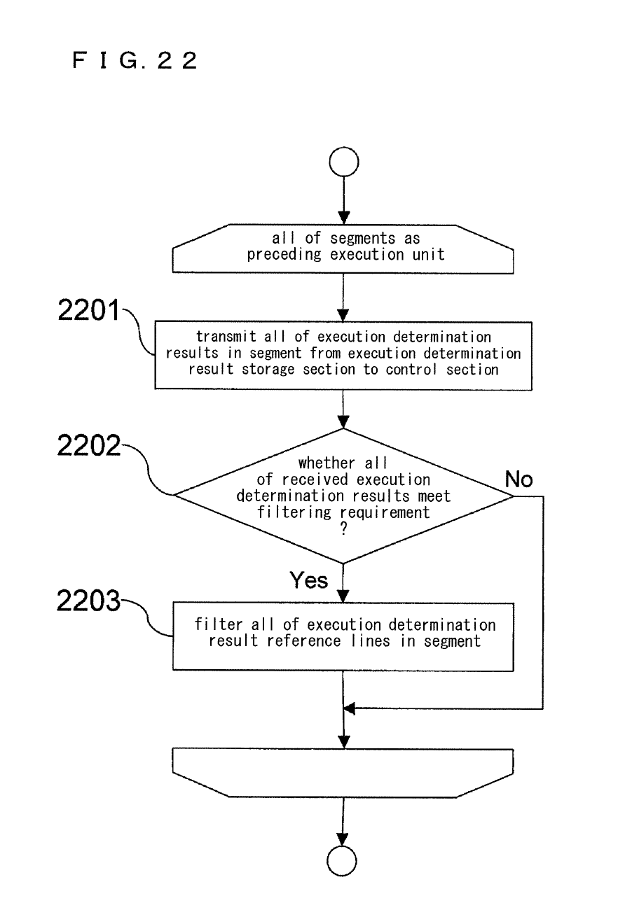

FIG. 22 is a flow chart illustrating the filtering process per preceding execution unit in all of the execution determination result reference lines controlled in Step 402 by the control section 2003. In Step 2201, all of the execution determination results in the target segment are transmitted from the execution determination result storage section 2002 to the control section 2003. In Step 2202, the control section 2003 determines whether the received execution determination results meet a filtering requirement of the target segment. When the control section 2003 determines that the filtering requirement is met, all of the execution determination result reference lines in the target segment are subjected to the filtering process in Step 2203. When the control section 2003 determines that the filtering requirement is not met, the target segment is not filter, and the process ends.

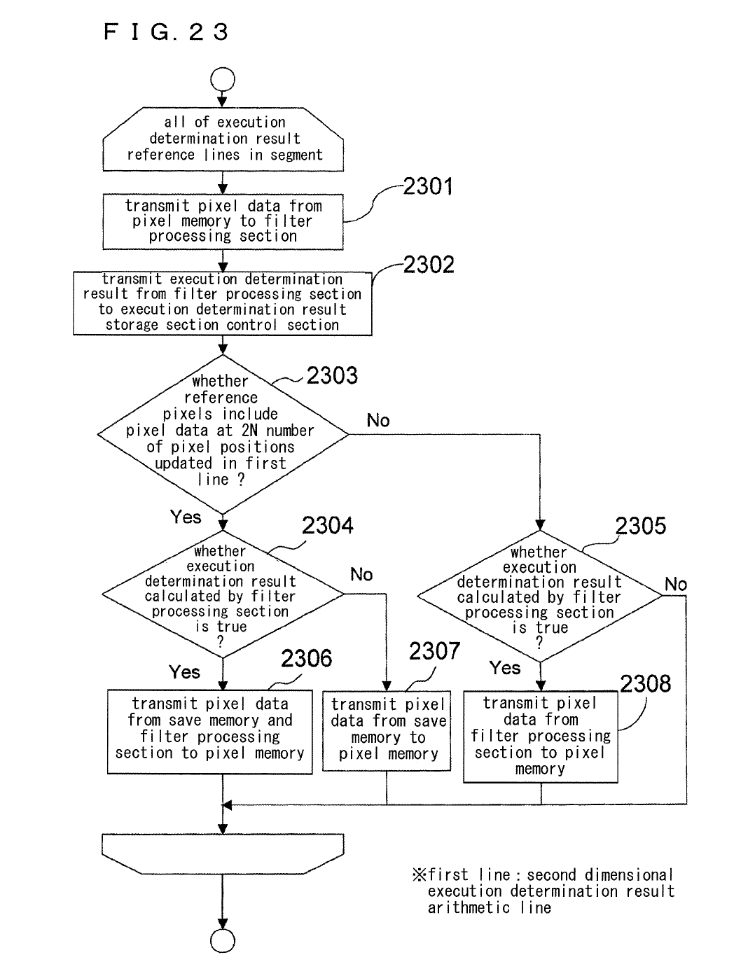

FIG. 23 is a flow chart illustrating the filtering process per preceding execution unit in all of the execution determination result reference lines in the target segment controlled in Step 2203 by the control section 2003. In Step 2301, the input pixel selecting section 2007 selects all of the pixel data necessary for filtering the lines from the pixel memory 2004 and transmits the selected pixel data to the filter processing section 2001. In Step 2302, the filter processing section 2001 calculates the execution determination results and transmits the calculated execution determination result to eh control section 2003. In Step 2303, the control section 2003 determines whether the reference pixel data includes a group of pixel data at 2N number of data positions updated in the first lines. The process proceeds to Step 2304 when the control section 2003 determines that the pixel data is included therein, while proceeding to Step 2305 when determined otherwise. In Step 2304, the control section 2003 determines whether the execution determination results received from the filter processing section 2001 are true. The process advances to Step 2306 when determined as true, while proceeding to Step 2307 when determined as false. In Step 2305, the control section 2003 determines whether the execution determination results received from the filter processing section 2001 are true. The process advances to Step 2308 when determined as true, while the filtering process is not executed for the target lines and then ends when determined as false. In Steps 2306 and 2307, the output pixel selecting section 2006 selects the pixel data necessary for filtering the target lines as described below and transmits the selected pixel data to the pixel memory 2004. The pixel data at 2N number of data positions updated in the first lines is selected from the save memory 2005, and the other pixel data is selected from the filter processing section 2001. In Step 2307, the pixel data of the pixel memory 2004 is not updated with the pixel data from the filter processing section 2001. Steps 2301 and 2308 are respectively similar to Steps 2103 and 2108.

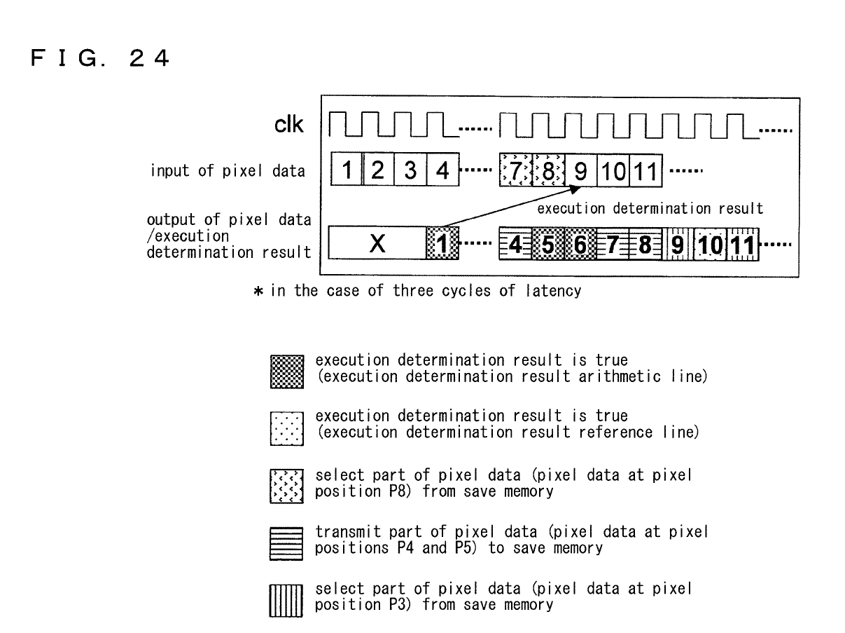

The operation of the filter device according to the exemplary embodiment 3 is described referring to an example in which the applied two dimensional filter is defined similarly to the exemplary embodiment 3. To filter brightness components, the control section 2303 outputs the control signal so that the filtering process which follows the processing order illustrated in, for example, FIG. 14 is executed similarly to the exemplary embodiment 2. FIG. 24 illustrates a waveform when the filtering process which follows the processing order illustrated in FIG. 14 is executed, wherein latency are similar to FIG. 32. In the example, the execution determination result of the execution determination result arithmetic line 1 is calculated in an earlier cycle than the filtering process of the execution determination result reference lines 9-11 in the same segment, which prevents the throughput of the pipeline process from deteriorating. In the filtering process of the first lines 3, 4, 7, and 8, the pixel data at the data positions P4 and P5 (see FIG. 29) is transmitted to the save memory 2005. In the filtering process of a group of pixel data on the lines 9 and 11 of the first dimensional inter-block boundary (including the pixel data at the data positions updated in the first line as the reference pixels), the output pixel selecting section 2006 selects the pixel data from the save memory 2005 as the pixel data at the data position P3 (see FIG. 29) and transmits the selected pixel data to the pixel memory 2004, and selects the pixel data from the filter processing section 2001 as the pixel data at any other positions and transmits the selected pixel data to the pixel memory 2004. In the filtering process of a group of pixel data on the first lines 7 and 8 (including the pixel data at the data positions updated in the first line adjacent to the reference pixels), the input pixel selecting section 2007 selects the pixel data from the save memory 2005 as the pixel data at the data position P8 (see FIG. 29) and transmits the selected pixel data to the filter processing section 2001, and selects the pixel data from the pixel memory 2004 as the other pixel data and transmits the selected pixel data to the filter processing section 2001. Therefore, when the preceding execution unit is set in all of the horizontal and vertical inter-block boundaries between adjacent filtering units, an image thereby obtained is similar to that of the filtering process which follows a standard filtering process.

Since the filtering unit is the pixel block including 8×8 pixels, the minimum required number of storage bits of the pixel memory 2004 is 1024. While eight execution determination results are written in FIG. 24, one execution determination result is read, therefore, the execution determination result storage section 2002 has seven storage bits. The save memory 2005, which stores therein the pixel data at the data positions P4 and P5 of the first lines 3 and 4 (see FIG. 29) and the pixel data at the data positions P5 of the first lines 7 and 8 (see FIG. 29), has number of storage bits 8×6=48.

In the filter device according to the exemplary embodiment 3, the preceding execution unit can be set in all of the horizontal and vertical inter-block boundaries per filtering unit although the applied two dimensional filter meets the condition 2. The only pixel data stored in the save memory 2005 is 2N number of pixel data updated in the first lines. Therefore, an area increase in a substrate mounted with the structural elements is minimized.

The two dimensional filter used in the exemplary embodiment 3 meets the following condition 3, making it necessary to reference the updated pixel data of the adjacent first line stored in the save memory. Therefore, the input pixel selecting section 2007 is an indispensable structural element.

Condition 3: The reference pixels for filtering the first lines include the pixel data updated in the filtering process of the adjacent inter-block boundary.

As far as the two dimensional filter is configured so that the condition 3 is not met (for example, M=1 in the two dimensional filter used in the exemplary embodiment 3), it is unnecessary to provide the input pixel selecting section 2007, in which case the pixel data from the pixel memory 2004 is always transmitted to the filter processing section 2001.

### Exemplary Embodiment 4

A possible way to further reduce the number of processing cycles is to increase a degree of parallelism in the filtering process of the execution determination result arithmetic lines in the filter device according to the exemplary embodiment 1. This, however, unfavorably leads to less processing cycles in which the execution determination result arithmetic latency and the filtering result arithmetic latency can be concealed by the pipeline process.

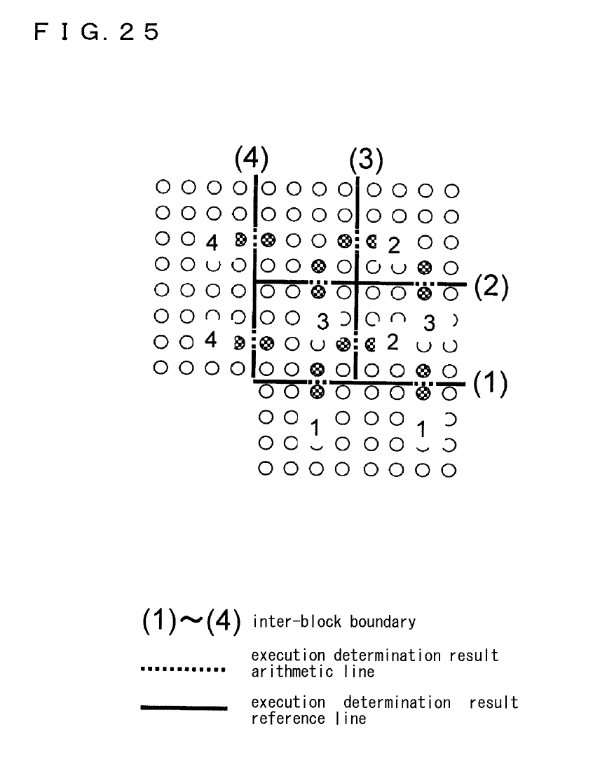

FIG. 25 illustrates an example in which the degree of parallelism in the filtering process of the execution determination result arithmetic lines is increased to “2” in a two dimensional filter similar to those of the exemplary embodiments 2 and 3. Then, the cycles required for filtering the execution determination result arithmetic lines, which are originally eight cycles, are reduced to four cycles, and the pixel data updated in the filtering process of the 1^{st} (or 2^{nd}) line is referenced in the filtering process of the 3^{rd} (or 4^{th}) line. Therefore, when the degree of parallelism in the filtering process of the execution determination result arithmetic lines is increased to “2” and a filtering order of FIG. 25 is adopted in place of FIG. 4, numbers of processing cycles in which the execution determination result arithmetic latency and the filtering result arithmetic latency can be concealed by the pipeline process are respectively reduced to three cycles from seven cycles, and to one cycle form three cycles.

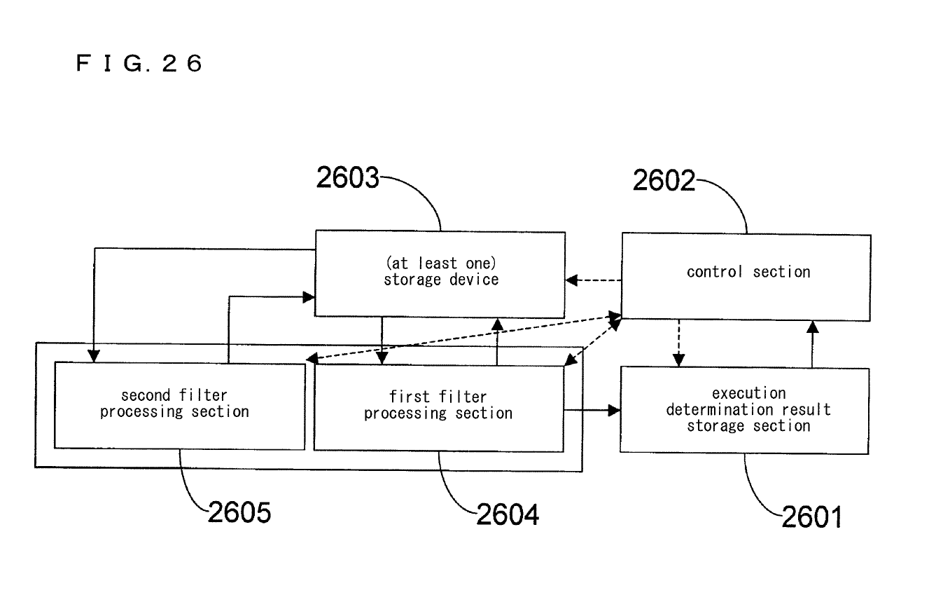

A filter device according to an exemplary embodiment 4 of the present invention can overcome such a technical disadvantage. The filter device according to the exemplary embodiment 4 is structurally characterized as illustrated in FIG. 26. The filter device according to the exemplary embodiment 4 comprises a storage device 2603 (similar to the storage device 301 in the filter device according to the exemplary embodiment 1 illustrated in FIG. 3), an execution determination result storage section 2601 (similar to the execution determination result storage section 304 in the filter device according to the exemplary embodiment 1 illustrated in FIG. 3), a control section 2602, a first filter processing section 2604, and a second filter processing section 2605.

The first filter processing section 2604 executes the filtering process of the execution determination result arithmetic lines while transmitting and receiving the pixel data to and from the storage device 2603. The second filter processing section 2605 executes the filtering process of the execution determination result reference lines while transmitting and receiving the pixel data to and from the storage device 2603. After the first filter processing section 2604 executes the filtering process of a plurality of execution determination result arithmetic lines, the control section 2602 references the execution determination results received from the execution determination result storage section 2601. In the case where a reference result thereby obtained meets a filtering execution determination, the control section 260 transmits control signals to the storage device 2603 and the execution determination result storage section 2601, and transmits and receives control signals to and from the first filter processing section 2604 and the second filter processing section 2605, so that the second filter processing section 2605 executes the filtering process of the execution determination result reference lines.

In the description given below, there is only one storage device 2603, and the pixel data before and after the filtering process is stored in the same storage space of the storage device 2603.

A filtering flow per filtering unit controlled by the control section 2602 is similar to the flow illustrated in FIG. 4C. In the flow chart illustrating the filtering process per preceding execution unit of all of the execution determination result arithmetic lines (controlled in Step 401 by the control section 2602), the filter processing section 302 in FIG. 5 is replaced with the first filter processing section 2604, and the control section 303 is replaced with the control section 2602.

A filtering flow per preceding execution unit in all of the execution determination result reference lines (controlled in Step 402 by the control section 2602) is similar to the flow illustrated in FIG. 6.

In the flow chart illustrating the filtering process of all of the execution determination result reference lines in the target segment (controlled in Step 603 by the control section 2602), the filter processing section 302 in FIG. 7 is replaced with the second filter processing section 2605, and the control section 303 is replaced with the control section 2602.

Hereinafter, the operation of the filter device according to the present exemplary embodiment 4 is described referring to an example in which the applied two dimensional filter is defined as follows. The filtering requirement is that all of the execution determination results in the execution determination result arithmetic lines of the segment are true.
filtering unit: pixel block including 8×8 pixels
filtering order: horizontal>=vertical, starting from the inter-block boundary including 8×8 pixels
other parameters: M=1, N=1, B=4, A=1, L (1)=3

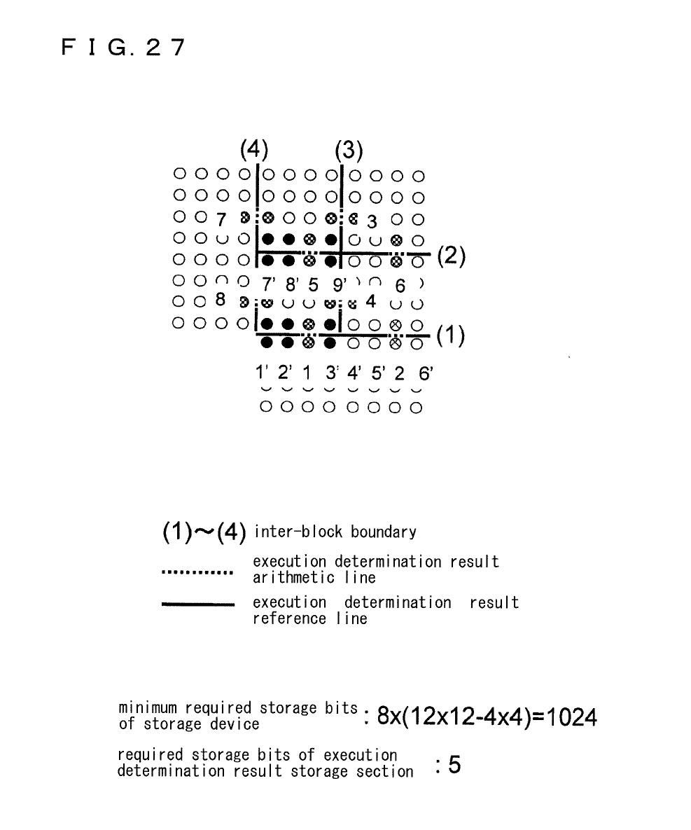

To filter brightness components, the control section 2602 outputs a control signal as, for example, illustrated in FIG. 27. First, the first filter processing section 2604 executes the filtering process of the execution determination result arithmetic lines (1^{st}-8^{th} lines) in eight segments of the inter-block boundaries (1)-(4). After that, the second filter processing section 2605 executes the filtering process of the execution determination result reference lines (1^{st}-24^{th} lines) in eight segments depending on the execution determination results of the execution determination result arithmetic lines. The 1′^{st}-24′^{th} execution determination result arithmetic lines in the respective segments not illustrated in the drawing are subjected to the filtering process in the same filtering order as the 1′^{st}-3′^{rd} lines.

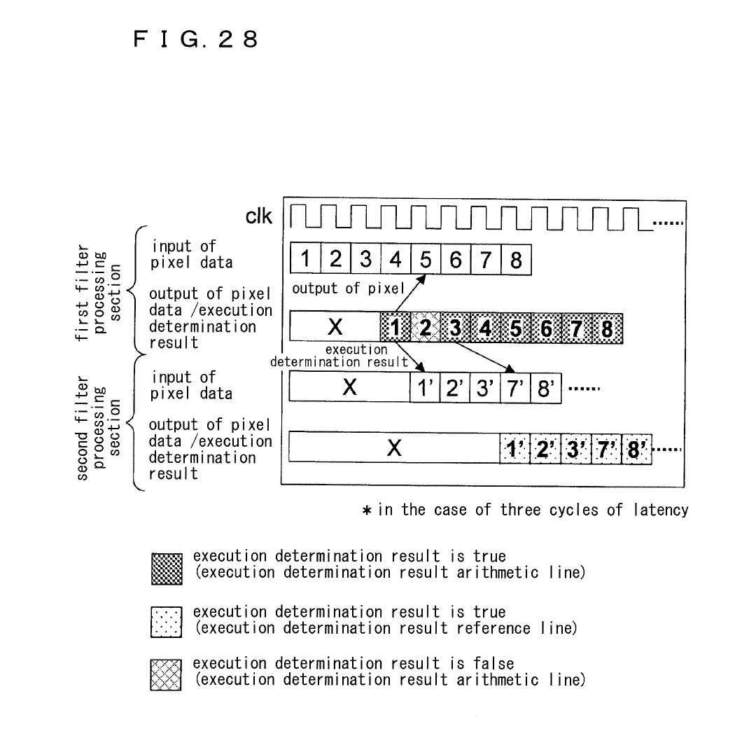

FIG. 28 illustrates a waveform when the filtering process which follows a processing order illustrated in FIG. 27 is executed, wherein latency are similar to FIG. 32. In the example, the execution determination result of the execution determination result arithmetic line 2 is false, therefore, the filtering process of the execution determination result reference lines 4′, 5′, and 6′ is skipped to save processing time and power. Further, the first filter processing section 2604 alone executes the filtering process of the execution determination result arithmetic lines, therefore, the number of cycles that can conceal the execution determination result arithmetic latency remains unchanged. The second filter processing section 2605 which executes the filtering process of the execution determination result reference lines alone can execute the filtering process in parallel with the first filter processing section 2604. Further, a storage period and a storage volume are both reduced because the second filter processing section 2605, which executes the filtering process in parallel with the first filter processing section 2604, sequentially reads the execution determination results written in the execution determination result storage section 2601 by the first filter processing section 2604.

Because the filtering unit is an 8×8 pixel block, the minimum required number of storage bits of the storage device 2603 is 8×(12×12−4×4)=1024. The number of storage bits of the execution determination result storage section 2601 is 8−3=5 because three execution determination results are read while eight execution determination results are written.

The filter device according to the exemplary embodiment 4 can effectuate the parallel process without reducing the number of cycles that can conceal the execution determination result arithmetic latency, and further reduce the storage period and storage volume of the execution determination results which are stored in the execution determination result storage section.

The exemplary embodiments 1-4 were described based on the filtering process of the brightness components. The brightness components and color difference components are similarly filtered, and the only difference therebetween is number of inter-block boundaries and number of lines when the same filtering unit is employed in the case where a color difference format is, for example, 4:2:0. Therefore, the color difference component can be similarly filtered.

In the description of the exemplary embodiments 1 and 4, there is only one storage device 301, 2603, and the pixel data before and after the filtering process is stored in the same space of the storage device. The pre-filtering pixel data and the post-filtering pixel data may be separately stored in different spaces of the storage device or may be separately stored in different storage devices. In the case where the pixel data are thus separately stored and the execution determination results of the execution determination result arithmetic lines in a segment are false, the pixel data is copied in place of filtering the execution determination result reference lines in the same segment. The pixel data may be copied in the storage device 301, 2603, or may be copied by way of the filter processing section 302, 2604, 2605.

In the description of the exemplary embodiments 2 and 3, there is only one pixel memory 1504, 2004, and the pixel data before and after the filtering process is stored in the same space of the pixel memory. The pre-filtering pixel data and the post-filtering pixel data may be separately stored in different spaces of the pixel memory or may be separately stored in different pixel memories. In the case where the pixel data are thus separately stored and the execution determination results of the execution determination result arithmetic lines in a segment are false, the pixel data is copied in place of filtering the execution determination result reference lines in the same segment. The pixel data may be copied in the pixel memory 1504, 2004, or may be copied by way of the filter processing section 1501, 2001.

### INDUSTRIAL APPLICABILITY

The filter device according to the present invention is applicable to an image encoding device and an image decoding device.

### DESCRIPTION OF REFERENCE SYMBOLS

301, 2601 at least one storage device
302, 1501, 2001 filter processing section
303, 1503, 2003, 2602 control section
304, 1502, 2002, 2601 execution determination result storage section
401 step of filtering all of execution determination arithmetic lines
402 step of filtering all of execution determination result reference lines
1504, 2004 at least one pixel memory
1505 duplication memory
1506 pixel selecting section
2005 save memory
2006 output pixel selecting section
2007 input pixel selecting section
2604 first filter processing section
2605 second filter processing section

What is claimed is:

1. A filter device, comprising:
a filter processing section configured to execute a filtering process of data at arbitrary data positions included in a filtering region, the filtering process having a dependency on a filtering order and the execution per se of the filtering process of at least a part of the data and determine the execution of the filtering process at the arbitrary data positions; and
a control section configured to control the filtering process executed by the filter processing section, wherein
the control section makes the filter processing section execute the filtering process at a group of first data positions necessary to determine the execution of the filtering process at a second data position which is one of the arbitrary data positions, and the control section makes the filter processing section execute the filtering process at the second data position when the execution determination results obtained by the filter processing section at the group of first data positions are true.

2. The filter device as claimed in claim 1, further comprising an execution determination result storage section configured to store therein the execution determination results obtained by the filter processing section, wherein the control section makes the execution determination result storage section store therein the execution determination results at the group of first data positions and reads the execution determination results at the group of first data positions from the execution determination result storage section, and the control section makes the filter processing section execute the filtering process at the second data position when the read execution determination results are true.

3. The filter device as claimed in claim 2, wherein
the execution determination result storage section stores therein the execution determination results obtained by the filter processing section at E number of data positions (E is an integral number meeting E>=2),
number of data positions X in the group of first data positions is an integral number meeting X>=E, and
the E is expressed by a formula (E=X−RW) in which the X and number of times RW (RW is an integral number meeting RW>=0) when the execution determination result is transmitted to and received from the execution determination result storage section at the same time are variables.

4. The filter device as claimed in claim 1, wherein
the filtering process is a two dimensional filtering process in which the filtering process is executed in a first direction and then executed in a section direction orthogonal to the first direction.

5. The filter device as claimed in claim 4, wherein
the two dimensional filtering process is a deblock filtering process.

6. The filter device as claimed in claim 5, wherein
the deblock filtering process is compliant with VC-1 standard.

7. The filter device as claimed in claim 4, wherein
the first direction is a horizontal direction, and the second direction is a vertical direction.

8. The filter device as claimed in claim 1, wherein
the filtering region is a region of 4M×4N (M and N are integral numbers at least 1) number of the data.

9. The filter device as claimed in claim 1, wherein
the data is pixel data, and
the data positions are data positions of the pixel data.

10. The filter device as claimed in claim 4, wherein
the control section controls the filter processing section so that all of the data at the group of first data positions in the first direction and all of the data at the group of first data positions in the second direction are filtered first.

11. The filter device as claimed in claim 4, wherein
the control section controls the filter processing section so that all of the data at the group of first data positions in the first direction or all of the data at the group of first data positions in the second direction are filtered first.

12. The filter device as claimed in claim 9, wherein
the control section controls the filter processing section so that the data at all of the first data positions in one of inter-block boundaries between a unit block including a plurality of the data two-dimensionally disposed and a plurality of adjacent unit blocks around the unit block are filtered first.

13. The filter device as claimed in claim 10, further comprising:
at least a storage device configured to store therein data in the filtering region;
a duplication memory configured to store therein the data at a plurality ones of the group of first data positions in the second direction; and
a data selecting section configured to select one of the data stored in the storage device and the data stored in the duplication memory and output the selected data to the filter processing section.

14. The filter device as claimed in claim 10, further comprising:
at least a storage device configured to store therein the data in the filtering region;
a save memory configured to store therein post-filtering data as a result of the filtering process by the filter processing section to the data at the plurality ones of the group of first data positions included in the second direction; and
an output data selecting section configured to select one of the post-filtering data stored in the save memory and a filtering result outputted from the filter processing section.

15. The filter device as claimed in claim 1, wherein
the filter processing section comprises:
a first filtering section configured to filter data at the group of first data positions; and
a second filtering section configured to filter data at a group of second data positions.

16. The filter device as claimed in claim 13, wherein
the first data position where the data is stored in the duplication memory is a data position where the data is updated in the filtering process by the filter processing section, and
the data selecting section selects the data stored in the duplication memory at the data position where the data is stored in the duplication memory, and selects the data stored in the storage device at the data position where the data is not stored in the duplication memory.

17. The filter device as claimed in claim 14, further comprising an input data selecting section configured to select one of the data stored in the storage device and the filtered data stored in the save memory and output the selected data to the filter processing section.

18. The filter device as claimed in claim 17, wherein
the first data position where the data is stored in the save memory is a data position where the data is updated in the filtering process by the filter processing section, and
in the filtering process at the first data positions in the second direction, the input data selecting section selects the filtered data stored in the save memory at the data position where the filtered data is stored in the save memory, and selects the data stored in the storage device at the data position where the filtered data is not stored in the save memory.

19. The filter device as claimed in claim 14, wherein
the first data position where the data is stored in the save memory is a data position where the data is updated in the filtering process by the filter processing section, and
the output data selecting section selects the filtered data stored in the save memory at the data position where the filtered data is stored in the save memory, and selects the filtering result outputted from the filter processing section at the data position where the filtered data is not stored in the save memory.

20. The filter device as claimed in claim 14, wherein
the control section controls the filter processing section so that filtered data is written in the save memory in the filtering process at the first data position in the second direction where the filtered data is stored in the save memory, and the control section controls the filter processing section so that filtered data is written in the storage device in the filtering process at any data position but the first data position in the second direction where the filtered data is stored in the save memory.

21. The filter device as claimed in claim 15, wherein
the control section makes the second filter processing section execute the filtering process when the execution determination result is true.

22. The filter device as claimed in claim 1, wherein
the filter processing section compares the data to at least a threshold value and calculates the filtering execution determination based on the comparison, and filters the data when the execution determination result thereby obtained is true.

23. The filter device as claimed in claim 22, wherein
the at least a threshold value is retained by the filter processing section or supplied by the control section to the filter processing section.

24. The filter device as claimed in claim 4, wherein
the data is pixel data which is a data unit constituting image data,
the data position is a data position of the image data, and
the first data position is a data position on a third line from a base end line in a segment of the image data.

25. The filter device as claimed in claim 24, wherein
the second data position is a data position on first, second, and fourth lines from the base end line in the segment.

26. A filter method wherein data at arbitrary data positions included in a filtering region are subjected to a filtering process having a dependency on a filtering order and execution per se of the filtering process of at least a part of the data, comprising:
a first step for executing a filtering process including an execution determination to data at the group of first data positions necessary to determine the execution of the filtering process of data at a second data position which is one of the arbitrary data positions; and
a second step for executing the filtering process of the data at the second data position when a result of the execution determination in the first step is true. The filter method thus technically characterized can improve the efficiency of the pipeline process.

27. The filter method as claimed in claim 26, wherein the execution determination results at the group of first data positions are stored in the first step, and
the execution determination results at the group of first data positions stored in the first step are read, and the filtering process is executed at the second data position when the read execution determination results are true in the second step.

28. The filter method as claimed in claim 26, wherein
the execution determination results obtained at E (E is an integral number meeting E>=2) number of data positions are stored in the first step,
number of data positions X in the group of first data positions is an integral number meeting X>=E, and
the E is expressed by a formula (E=X−RW) in which the X and number of times RW (RW is an integral number meeting RW>=0) when the execution determination result is transmitted to and received from a execution determination result storage section at the same time are variables.

29. The filter method as claimed in claim 26, wherein
the filtering process is a two dimensional filtering process in which the filtering process is executed in a first direction and then executed in a section direction orthogonal to the first direction.

30. The filter method as claimed in claim 29, wherein
the two dimensional filtering process is a deblock filtering process.

31. The filter method as claimed in claim 30, wherein
the deblock filtering process is compliant with VC-1 standard.

32. The filter method as claimed in claim 29, wherein
the first direction is a horizontal direction, and the second direction is a vertical direction.

33. The filter method as claimed in claim 26, wherein
the data is pixel data, and
the data positions are data positions of the pixel data.

34. The filter method as claimed in claim 29, wherein
all of the data at the group of first data positions in the first direction and all of the data at the group of first data positions in the second direction are filtered first in the first step.

35. The filter method as claimed in claim 29, wherein
all of the data at the group of first data positions in the first direction or all of the data at the group of first data positions in the second direction are filtered first in the first step.

36. The filter method as claimed in claim 33, wherein
the data at all of the first data positions in one of inter-block boundaries between a unit block including a plurality of the data two-dimensionally disposed and a plurality of adjacent unit blocks around the unit block are filtered first in the first step.

37. The filter method as claimed in claim 34, wherein
the data at a plurality ones of the group of first data positions in the section direction is duplicated in the first step, and
the data at the plurality of second data positions is filtered in the second step based on a duplication result obtained in the first step.

38. The filter method as claimed in claim 34, wherein
the filtered data is stored at the data position included in the group of first data positions in the second direction where the execution determination result is true in the first step, and
when the data at the second data position is filtered to be updated in the second step, the stored filtered data is handled as the filtered and updated data at the data position where the filtered data is stored in the first step.

39. The filter method as claimed in claim 26, wherein
the second step is executed in parallel with the first step as soon as the execution determination result is stored in the first step.

40. The filter method as claimed in claim 26, wherein
the data is compared to at least a threshold value, and the filtering execution determination is calculated based on the comparison in the first step.

41. The filter method as claimed in claim 29, wherein
the data is pixel data which is a data unit constituting image data,
the data position is a data position of the image data
the first data position is a data position on a third line from a base end line in a segment of the image data.

42. The filter method as claimed in claim 41, wherein
the second data position is a data position on first, second, and fourth lines from the base end line in the segment.
